(19) United States
(12) Patent Application Publication
(10) Pub. No.: US 2005/0132329 A1
(43) Pub. Date: Jun. 16, 2005

(54) Method and system for establishing a hierarchically structured web site for e-commerce

(76) Inventor: Hendra Suwanda, Ontario (CA)

Correspondence Address: IBM CORPORATION, 3039 CORNWALLIS RD., DEPT. T81 / B503, PO BOX 12195, REASEARCH TRIANGLE PARK, NC, 27709, US

(21) Appl. No.: 10/508,883

(22) PCT Filed: Mar. 20, 2003
(86) PCT No.: PCT/GB03/01342

(30) Foreign Application Priority Data
Mar. 27, 2002 (CA) 2379306

(51) Int. Cl. G06F 9/44

(52) U.S. Cl. 717/120

(57) ABSTRACT

The invention provides a hierarchically structured store web site for use on the internet including: a base store site module having at least one entry port for communication with the internet; and, at least one child module of the base store site module having an entry port; the entry port of the base store site module being linked to the entry port of the child module for communication between the base store site and the child module. The invention also provides a method and software for establishing the web site.

### FIELD OF THE INVENTION

This invention relates to the field of web sites; and more particularly to the establishment of hierarchically structured web sites that are suitable for use in e-Commerce on the internet.

### BACKGROUND OF THE INVENTION

Building a web site, particularly an e-commerce site is a complex undertaking requiring the involvement of teams, from different disciplines. There are many topics that should be addressed when building such a website and these topics will be identified and discussed below.

The site architecture provides a blueprint describing the design of the site. It describes the different parts of the site, their purpose and their interaction, for instance how one part is related to the other from the point of view of a user navigating the site. Typically, each part is made up by a number of (Web) pages serving specific purposes. Traditionally architecture as a whole reflects the purpose of the site from the user point of view; the architecture represents a model of the actual Web site for example the look and feel of the Web site and the business logic and security.

Look and Feel

Once the site architecture has been developed a creative design team may design and create each page specified by the architecture. For user friendliness consistent page layout and content presentation is an important focus of the activity by the creative design team.

Business Logic and Security

A commerce server is used to provide operational support for the web site. This business logic is typically invoked from the Web pages using a Common Gateway Interface (CGI) or Servlet mechanism. It typically requires access to information stored in a (relational) database. Access control policy of the site determines who should have access to particular site information. Both logic and database design (which may include data modeling and schema design) are necessary to support this.

Application Deployment and Data Load

Before testing the store web site, a substantial amount of work needs to be done to assure a useful test result. Web assets such as HTML, GIF, and JSP™ files as used need to be deployed into a test server. Business logic for the commerce application including the data accesses logic also needs to be deployed. Lastly, the relevant persistent data needs to be loaded into the database.

Site Testing

Before opening the store web site online, both functional and nonfunctional (e.g. performance) characteristics must be tested.

Site Opening

As soon as the producer of the store web site is satisfied with the results of all functional and nonfunctional testing, the real site on the production server may deployed and opened for actual use.

Operating and Maintaining the Site

Like any application software, the site should be properly maintained. Examples of some of the tasks that may be required in the maintenance of the site include: data updates and cleanup, data mining and analysis, merchandising and promotion, improving existing functions and introducing new functions, and retesting, among others.

Motivations for Site Architectures

Somewhere between the requirement analysis phase and the design phase, some of the relevant questions to be addressed by the architect of a Web site relate to how visitors should view and experience the site. Some of the typical questions that may be asked may include:
What are the pages the visitors may visit in the site and how should the visitor experience the site between the points of entering and exiting the site?
What (dynamic) data should be displayed on those pages?
How should that data be displayed or arranged on the page?
What action (business logic) should be invoked during a navigation from one page to another of the Web site?
   These are questions related to Steps 1, 2, and 3 described earlier. In order to answer these questions satisfactory, the architect should create a model of the desired site. One important aspect of the model would be the creation of a blueprint which provides a description of the site from the visitor viewpoint. This blueprint would represent the site architecture that should address most of the questions raised above, except perhaps the details of the look and feel of the site and the details of the business logic. Those should be addressed at the next level of details.

It is important to finalize and review the site architecture before building the Web site. Not only does the blueprint serve as a design document outlining what will be built in the project, but it also provides a common base for the cooperation of both the creative design team and the programming team. This document allows both teams to proceed with their work in parallel with a common objective for building the Web site. The topic of different teams working together in building a Web application is also discussed in When Worlds collide [1].

The goal of this invention is to present a methodology and notation for describing and building a site architecture for an e-commerce Web site. Structured design methodology is applied to the area of Web site design. The structure the architecture of a typical site using this approach will be shown as well as a convenient method to express that architecture in notation which will be described below. The methodology will enable the structuring of the site in components making benefits of componentization possible. It may also facilitate the introduction of the tools to help in the creation of the site. The next section will describe the context in which site architecture belongs in the overall picture of the architecture of Web applications.

A Logical View of the Architecture of Web Applications

In describing the architecture of a Web application many people would start with a platform such as J2EE [2] and try to describe the architecture of the application using the idioms provided by that platform. The emphasis of such platform or framework has been largely focused toward the structuring of the server side components. It appears that the structuring and modeling of the site from the visitor point of view has not been adequately addressed. This is perhaps because a different set of abstractions would be required in order to describe a site architecture. It now appears that it would be useful to use site architecture to model the site from the visitor point of view and to define the connection between the site architecture to commerce server architecture. Logically, it can be considered that the architecture of a Web application (such as e-commerce application) may be divided into site architecture and server architecture with a well defined interface for their interactions.

In order to understand the motivation of the approach to model site architectures including site navigation, it is instructive to look at the details of one current Web programming model which serves as the foundation of the implementation of navigation in many e-commerce sites. We then contrast this model with the navigation approach of the invention.

### DISCLOSURE OF THE INVENTION

In accordance with the present invention there is now provided a hierarchically structured store web site for use on the internet comprising: a base store site module having at least one entry port for communication with the internet; and, at least one child module of the base store site module having an entry port; the entry port of the base store site module being linked to the entry port of the child module for communication between the base store site and the child module.

Preferably the present invention provides for a web site wherein at least one child module has an entry port and an exit port. Preferably the web sites provides at least one child module has at least one entry port and at least one exit port; and the base module has at least one entry port; at least one of the entry ports of the child is linked to at least one entry port of the base module.

Preferably the present invention provides for a web site wherein at least one child module has at least one entry port and at least one exit port; the base module has at least one entry port and at least one exit port; and at least one of the entry ports of the child is linked to at least one entry port of the base module. Preferably the present invention provides for a web site having at least one of the entry ports, and at least one of the exit ports of the at least one child module are linked, respectively, to at least one of the base module's entry ports, and at least one of the base module's exit ports. Preferably the present invention provides for the web site having a base module which has a plurality of entry ports, and at least some of the plurality of entry ports of the base module are linked to the entry port of the at least one child module.

Preferably the present invention provides for a web site wherein at least one child module which has a plurality of exit ports, and at least some of the plurality of exit ports of the child module are linked to one exit of the base module. Preferably the present invention provides for the web site wherein at least one of the exit ports which is linked to at least one of the child module and is linked to at least one of the entry ports of another child module. Preferably the present invention provides for a web site wherein the base store site module has at least one entry port for communication with the internet; at least one child module being selected from the set comprising: a store front (page) module, a shopping (area) module, a customer service (area) module, an information (area) module, or an auction (area) module.

Preferably the present invention provides for the web site wherein the base store site module having at least one entry port for communication with the internet and at least one exit port; and the at least one exit port of the base store site module being available for linking with an exit port of a child module.

Viewed from another aspect the present invention provides for a hierarchically structured modular web site for linkin; to the internet, comprising: a base module having at least one entry port for communication with the internet; and at least one child module, contained by the base module, having an entry port, the entry port of the al least one child module being linked with an entry port of the base module for communication between the base module and the child module.

Preferably the present invention provides for a hierarchically structured modular web site comprising a base module having at least one entry port for communication with the internet; and at least one child module having an entry port and an exit port, the entry port of the at least one child module being linked with an entry port of the base module for communication between the base module and the child module. Preferably the present invention provides for a web site wherein the base module having an exit port; the exit port of the at least one child module being linked to the exit port of the base module. Preferably the present invention provides for the web site wherein at least one child module comprising a plurality of child modules, each having entry ports, and at least one of the child modules having at least one exit port, at least one of which child module has an exit port linked to the entry port of another child module for communication of information between the modules.

Preferably the present invention provides for the web site having at least one child module comprising a plurality of child modules having entry ports, and at least one of the child modules having at least one exit port; at least one of the child modules has an exit port linked to the entry port of another child module for communication of information between the modules; and at least one exit port of at least one of the child modules has an exit port linked to the exit port of the base module.

Preferably the present invention provides for the web site having at least one child module comprising a plurality of child modules, having a plurality of entry and exit ports, at least one of which child modules has a number of exit ports linked to an exit port of the base module. Preferably the web site of provides for at least one child module comprising a plurality of child modules, having a plurality of entry and exit ports, at least one of which child modules has a number of entry ports linked to an entry port of the base module. Preferably the present invention provides for the web site having at least one child module having at least one specialized function.

Preferably the present invention provides for a web site having the base module comprising a base store site module which has at least one entry port for communication with the internet and at least one exit port; the at least one exit port of the base module being available for linking with an exit port of a child module; the at least one child module being selected from the set comprising: a store front module, a shopping module, a customer service module, an information module, or an auction module. Preferably the present invention provides for a web site having an entry port to a module comprising a URL address, and an exit port comprises an instruction to call a URL address.

Viewed from another aspect the present invention provides for a hierarchically structured modular web site for linking to the internet, to provide access to the web site, comprising: a base module having an entry port for communication with the internet; at least one child module, contained by the base module, having an entry port for linking with the entry port of the base module; and each module having at least one specialized function; each port being adapted for communication of information between modules linked therewith.

Preferably the present invention provides for a hierarchically structured modular web site comprising: at least one child module having an entry port for linking with the entry port of the base module and an exit port for linking with an entry port of another child module. Preferably the web site provides for the hierarchically structured modular web site comprising: at least one contained child module, comprising a termination module, having an exit port for linking to an exit port of an containing module. Preferably the present invention provides for the hierarchically structured modular web site comprising: at least one contained child module, comprising a termination module, having an exit port for linking to another web site.

Preferably the present invention provides for the hierarchically structured modular web site comprising: at least one contained child module, comprising a termination module, has at least one entry port and no exit port.

Viewed from another aspect the invention provides for a hierarchically structured modular web site for linking to the internet, to provide access to the web site, comprising: a base module having an entry port for communication with the internet; at least one contained child module contained within the base module, having an entry port for linking with the entry port of the base module and an exit port for linking with another contained child module.

Preferably the present invention provides for a hierarchically structured modular web site, comprising: a base module having an entry port for communication with the internet and at least one exit port; and a plurality of contained child modules contained within the base module, having at least one entry port for linking with the entry port of the base module and exit ports for linking with at least one other contained child module and the exit port of the base module.

Preferably the present invention provides for a hierarchically structured modular web site for linking to the internet, to provide access to the web site, comprising: an containing base module having an entry port for communication with the internet and for communication with an entry port of an contained child module for communication therewith; a contained child module having an entry port for linking with the entry port of the base module and an exit port for linking with another contained child module; a further contained child module having an entry port for linking with an entry port of a containing module and at least one exit port for linking with another further contained child module; at least one contained child module comprising a termination module having only an entry port for linking with an containing module; each module having at, least one specialized function; and each port being adapted for communication of information between modules linked thereby. Preferably the web site provides for a hierarchically structure modular web site wherein the termination module comprises a page module.

Preferably the present invention provides for a web site having a termination module comprising a portal having a link to another web site. Preferably the present invention provides for a web site having at least one contained child module comprising a termination module having only an entry port for linking with an entry port of a containing module has an exit port for linking with a plurality of other modules. Preferably the present invention provides for a web site having a termination module having an exit port for linking with the internet, in order to send information thereon.

Viewed from another aspect the present invention provides for a hierarchically structured modular store web site for linking to the internet, to provide access by customers to the web site, comprising: a base store module having an entry port for communication with the internet for customer access and an entry port of at least one child module for communication therewith; at least one child module having an entry port for linking with the entry port of the base module; the at least one child module, contained by the base store module, comprising: a module selected from a set comprising: a store front module, a shopping module, a customer service module, an information module; and each port being adapted for communication of information between modules linked thereby to provide navigational access by a customer to child modules within the web site.

Preferably the present invention provides for a hierarchically structured modular store web site for linking to the internet, to provide access by customers to the web site, wherein the child modules comprise: a store front module, and a shopping module. Preferably the web site provides for the store front module comprises a store front web page accessible by a customer; and the store front web page being adapted to display an index of other modules in the web site accessible to the customer.

Preferably the present invention provides for a web site having the store front module comprising a store front web page accessible by a customer; and the store front web page being adapted to display links to other modules in the web site accessible to the customer.

Preferably the present invention provides for a web site wherein the shopping area child module has exit ports linked to entry ports of child modules including a catalog section module and a checkout section module; the catalog section module having exit ports linked to entry ports of child modules including: a catalog front page module; product page module; and category virtual page module; the category virtual page module having exit ports linked to entry ports of child modules including a category page module, and a product list page module.

Preferably the present invention provides for the checkout section module has exit ports linked to entry ports of child modules including: shopping cart page; bill to page, ship to page, payment page, order submission page, and optionally, thank you page modules. Preferably the present invention provides for the store web site includes a customer service area child module linked by its entry port to an exit port of the store web site; and the customer service area child module having exit ports for linking to entry ports of a log section and registration section child modules. Preferably the invention provides for the login section child module has an exit port linked to entry ports of a login page child, and forgotten password page modules. Preferably the present invention provides for the registration section child module has an exit port linked to an entry port of a registration page child module.

Preferably the present invention provides for the store web site includes an information area (an about us area) child module having exit ports linked to entry ports of child; modules, including privacy page, news page, and contacts page modules. Preferably the invention provides for the base and child modules to be implemented by business logic functions of a data processing server.

Preferably the present invention provides for the business logic functions to be implemented by servlets or common gateway interface mechanisms and data storage for the web site store is maintained in a database of a database server. Preferably the invention provides for an advertising child module linked to an exit port of the store web site and adapted to send promotional information customers contacting the store web site by means of a common gateway interface presented to the customers. Preferably the present invention provides for the advertising module to be adapted to send promotional information to the customers based on information provided by the customers in viewing or selecting merchandise from the catalog section module. Preferably the present invention provides for at least one contained child module and the at least one contained child module, include at least one; contained child module.

Preferably the present invention provides for a module to include at least one contained child module and the at least one contained child module include at least one contained child module, and at least one child module contains a termination module. Preferably the present invention provides for a module to include at least one contained child module and the at least one contained child module include at least one contained child module, and at least one child module contains a termination module, the termination module having a link to another web site.

Preferably the present invention provides for a data processing system capable of being linked to the internet a hierarchically structured store web site for use on the internet comprising: establishing in the data processing system: a base store site module having at least one entry port for communication with the internet; at least one child module of the base store site module having an entry port; and the entry port of the base store site module being linked to the entry port of the child module for communication between the base store site and the child module.

Preferably the present invention provides for a method of for establishing a web site wherein the at least one child module has at least one entry port and at least one exit port; and the base module has at least one entry port; at least one of the entry ports of the child is linked to at least one entry port of the base module. Preferably the present invention provides for establishing a web site wherein at least one child module has at least one entry port and at least one exit port; the base module has at least one entry port and at least one exit port; and at least one of the entry ports of the child is linked to at least one entry port of the base module.

Preferably the present invention provides for establishing a web site wherein at least one of the entry ports, and at least one of the exit ports of the at least one child module are linked, respectively, to at least one of the base module's entry ports, and at least one of the base module's exit ports. Preferably the present invention provides for establishing a web site wherein the base module has a plurality of entry ports, and at least some of the plurality of entry ports of the base module are linked to the entry port of the at least one child module. Preferably the present invention provides for at least one of child module having a plurality of exit ports, and at least some of the plurality of exit ports of the child module are linked to one exit of the base module.

Preferably the present invention provides for establishing a web site wherein at least one of the exit ports of the at least one child module is linked to at least one of the entry ports of another child module.

Preferably the present invention provides for establishing a web site wherein the base store site module has at least one entry port for communication with the internet; the at least one child module being selected from the set comprising: a store front (page) module, a shopping (area) module, a customer service (area) module, an information (area) module, or an auction (area) module.

Preferably the present invention provides for establishing a web site wherein the base store site module has at least one entry port for communication with the internet and at least one exit port; the at least one exit port of the base store site module being available for linking with an exit port of a child module.

Viewed from another aspect the present invention provides a method of establishing in a data processing system capable of being linked to the internet a hierarchically structured modular web site for linking to the internet, comprising: establishing in the data processing system: a base module having at least one entry port for communication with the internet; and at least one child module, contained by the base module, having an entry port, the entry port of the at least one child module being linked with an entry port of the base module for communication between the base module and the child module. Preferably the present invention provides for establishing a hierarchically structured modular web site for linking to the internet, comprising: a base module having at least one entry port for communication with the internet; and at least one child module having an entry port and an exit port, the entry port of the at least one child module being linked with an entry port of the base module for communication between the base module and the child module.

Preferably the present invention provides for establishing a web site wherein the base module has an exit port; the exit port of the at least one child module being linked to the exit port of the base module.

Preferably the present invention provides for establishing a web site wherein the at least one child module comprises a plurality of child modules, each having entry ports, and at least one of the child modules having at least one exit port, at least one of which child module has an exit port linked to the entry port of another child module for communication of information between the modules. Preferably the present invention provides for establishing a web site wherein the at least one child module comprises a plurality of child modules having entry ports, and at least one of the child modules having at least one exit port, at least one of the child modules has an exit port linked to the entry port of another child module for communication of information between the modules; at least one exit port of at least one of the child modules has an exit port linked to the exit port of the base module.

Preferably the present invention provides for establishing a web site wherein the at least one child module comprises a plurality of child modules, having a plurality of entry and exit ports, at least one of which child modules has a number of exit ports linked to an exit port of the base module. Preferably the present invention provides for establishing a web site wherein the at least one child module comprises a plurality of child modules, having a plurality of entry and exit ports, at least one of which child modules has a number of entry ports linked to an entry port of the base module. Preferably the present invention provides for establishing a web site wherein each module has at least one specialized function.

Preferably the present invention provides for establishing a web site wherein the base module, comprises a base store site module which has at least one entry port for communication with the internet and at least one exit port; the at least one exit port of the base module being available for linking with an exit port of a child module; and the at least one child module being selected from the set comprising: a store front module, a shopping module, a customer service module, an information module, or an auction module. Preferably the present invention provides for establishing a web site wherein an entry port to a module comprises a URL address, and an exit port comprises an instruction to call a URL address.

Viewed from another aspect the present invention provides for a method of establishing in a data processing system capable of being linked to the internet a hierarchically structured modular web site for linking to the internet, to provide access to the web site, comprising: establishing in the data processing system: a base module having an entry port for communication with the internet; at least one child module, contained by the base module, having an entry port for linking with the entry port of the base module; and each module having at least one specialized function; each port being adapted for communication of information between modules linked therewith.

Preferably the present invention provides for establishing a hierarchically structured modular web site, comprising: at least one child module having an entry port for linking with the entry port of the base module and an exit port for linking with an entry port of another child module. Preferably the present invention provides for establishing a hierarchically structured modular web site comprising: at least one contained child module, comprising a termination module, having an exit port for linking to an exit port of an containing module. Preferably the present invention provides for establishing a hierarchically structured modular web site comprising: at least one contained child module, comprising a termination module, having an exit port for linking to another web site.

Preferably the present invention provides for establishing a hierarchically structured modular web comprising: at least one contained child module, comprising a termination module, has at least one entry port and no exit port.

Preferably the present invention provides for establishing in a data processing system capable of being linked to the internet a hierarchically structured modular web site for linking to the internet, to provide access to the web site, comprising: establishing in the data processing system: a base module having an entry port for communication with the internet; and at least one contained child module contained within the base module, having an entry port for linking with the entry port of the base module and an exit port for linking with another contained child module.

Preferably the present invention provides for establishing a hierarchically structured modular web site, comprising: a base module having an entry port for communication with the internet and at least one exit port; and a plurality of contained child modules contained within the base module, having at least one entry port for linking with the entry port of the base module and exit ports for linking with at least one other contained child module and the exit port of the base module.

Preferably the present invention provides for establishing a hierarchically structured modular web site for linking to the internet, to provide access to the web site, comprising: an containing base module having an entry port for communication with the internet and for communication with an entry port of an contained child module for communication therewith; an contained child module having an entry port for linking with the entry port of the base module and an exit port for linking with another contained child module; a further contained child module having an entry port for linking with an entry port of a containing module and at least one exit port for linking with another further contained child module; at least one contained child module comprising a termination module having only an entry port for linking with an containing module; each module having at least one specialized function; and each port being adapted for communication of information between modules linked thereby.

Preferably the present invention provides for establishing a hierarchically structure modular web site wherein the termination module comprises a page module. Preferably the present invention provides for establishing a hierarchically structure modular web site wherein the termination module comprises a portal having a link to another web site.

Preferably the present invention provides for establishing a hierarchically structured modular web site, wherein the at least one contained child module comprising a termination module having only an entry port for linking with an entry port of a containing module has an exit port for linking with a plurality of other modules. Preferably the present invention provides for establishing a hierarchically structured modular web site wherein the termination module has an exit port for linking with the internet, in order to send information thereon.

Preferably the present invention provides for establishing in a data processing system capable of being linked to the internet a hierarchically structured modular store web site for linking to the internet, to provide access by customers to the web site, comprising: establishing in the data processing system: a base store module having an entry port for communication with the internet for customer access and an entry port of at least one child module for communication therewith; at least one child module having an entry port for linking with the entry port of the base module; the at least one child module, contained by the base store module, comprising: a module selected from a set comprising: a store front module, a shopping module, a customer service module, an information module; and each port being adapted for communication of information between modules linked thereby to provide navigational access by a customer to child modules within the web site.

Preferably the present invention provides for establishing a hierarchically structured modular store web site for linking to the internet, to provide access by customers to the web site, wherein the child modules comprise: a store front module, and a shopping module. Preferably the present invention provides for establishing a web site wherein the store front module comprises a store front web page accessible by a customer; and the store front web page being adapted to display an index of other modules in the web site accessible to the customer.

Preferably the present invention provides for establishing a web site wherein the store front module comprises a store front web page accessible by a customer; and the store front web page being adapted to display links to other modules in the web site accessible to the customer.

Preferably the present invention provides for establishing a web site wherein the shopping area child module has exit ports linked to entry ports of child modules including a catalog section module and a checkout section module; the catalog section module having exit ports linked to entry ports of child modules including a catalog front page module; product page module; category virtual page module; and the category virtual page module having exit ports linked to entry ports of child modules including a category page module, and a product list page module. Preferably the present invention provides for establishing a web site wherein the checkout section module has exit ports linked to entry ports of child modules including: shopping cart page; bill to page, ship to page, payment page, order submission page, and optionally, thank you page modules.

Preferably the present invention provides for establishing a web site wherein the store web site includes a customer service area child module linked by its entry port to an exit port of the store web site; the customer service area child module having exit ports for linking to entry ports of a log section and registration section child modules. Preferably the present invention provides for establishing a web site wherein the login section child module has an exit port linked to entry ports of a login page child, and forgotten password page modules. Preferably the present invention provides for establishing a web site wherein the registration section child module has an exit port linked to an entry port of a registration page child module. Preferably the present invention provides for establishing a web site wherein the store web site includes an information area (an about us area) child module having exit ports linked to entry ports of child modules, including privacy page, news page, and contacts page modules.

Preferably the present invention provides for establishing a web site wherein the base and child modules are implemented by business logic functions of a data processing server. Preferably the present invention provides for establishing a web site wherein the business logic functions are implemented by servlets or common gateway interface mechanisms and data storage for the web site store is maintained in a database of a database server. Preferably the present invention provides for establishing a web site including an advertising child module linked to an exit port of the store web site and adapted to send promotional information customers contacting the store web site by means of a common gateway interface presented to the customers, Preferably the present invention provides for establishing a web site wherein the advertising module is adapted to send promotional information to the customers based on information provided by the customers in viewing or selecting merchandise from the catalog section module. Preferably the present invention provides for establishing, a web site wherein a, module includes at least one contained child module and the at least one contained child module include at least one contained child module. Preferably the present invention provides for establishing a web site wherein a module includes at least one contained child module and the at least one contained child module include at least one contained child module, and at least one child module contains a termination module. Preferably the present invention provides for establishing a web site wherein a module includes at least one contained child module and the at least one contained child module include at least one contained child module, and at least one child module contains a termination module, the termination module having a link to another web site.

Viewed from another aspect the present invention provides for a computer-readable information storage medium; programming means recorded on the medium for establishing: a hierarchically structured store web site for use on the internet comprising: a base store site module having at least one entry port for communication with the internet; at least one child module of the base store site module having an entry port; and the entry port of the base store site module being linked to the entry port of the child module for communication between the base store site and the child module.

Preferably the present invention provides for an article establishing a web site in accordance with wherein the at least one child module has an entry port and an exit port.

Preferably the present invention provides for an article for establishing a web site wherein the at least one child module has at least one entry port and at least one exit port; and the base module has at least one entry port; at least one of the entry ports of the child is linked to at least one entry port of the base module. Preferably the present invention provides for an article for establishing a web site wherein the at least one child module has at least one entry port and at least one exit port; the base module has at least one entry port and at least one exit port; and at least one of the entry ports of the child is linked to at least one entry port of the base module. Preferably the present invention provides for an article for establishing a web site wherein at least one of the entry ports, and at least one of the exit ports of the at least one child module are linked, respectively, to at least one of the base module's entry ports, and at least one of the base module's exit ports. Preferably the present invention provides for an article for establishing a web site wherein the base module has a plurality of entry ports, and at least some of the plurality of entry ports of the base module are linked to the entry port of the at least one child module.

Preferably the present invention provides for an article for establishing a web site wherein at least one of child module has a plurality of exit ports, and at least some of the plurality of exit ports of the child module are linked to one exit of the base module. Preferably the present invention provides for an article for establishing a web site wherein at least one of the exit ports of the at least one child module is linked to at least one of the entry ports of another child module. Preferably the present invention provides for an article for establishing a web site wherein the base store site module has at least one entry port for communication with the internet; the at least one child module being selected from the set comprising: a store front (page) module, a shopping (area) module, a customer service (area) module, an information (area) module, or an auction (area) module.

Preferably the present invention provides for an article for establishing a web site wherein the base store site module has at least one entry port for communication with the internet and at least one exit port; and the at least one exit port of the base store site module being available for linking with an exit port of a child module.

Viewed from another aspect the present invention provides an article comprising a computer-readable information storage medium; programming means recorded on the medium for establishing: a hierarchically structured modular web site for linking to the internet, comprising: a base module having at least one entry port for communication with the internet; at least one child module, contained by the base module, having an entry port, the entry port of the at least one child module being linked with an entry port of the base module for communication between the base module and the child module.

Preferably the present invention provides for an article for establishing a web site for linking to the internet, comprising: a base module having at least one entry port for communication with the internet; at least one child module having an entry port and an exit port, the entry port of the at least one child module being linked with an entry port of the base module for communication between the base module and the child module.

Preferably the present invention provides for an article for establishing a web site wherein the base module has an exit port; the exit port of the at least one child module being linked to the exit port of the base module. Preferably the present invention provides for an article for establishing a web site wherein the at least one child module comprises a plurality of child modules, each having entry ports, and at least one of the child modules having at least one exit port, at least one of which child module has an exit port linked to the entry port of another child module for communication of information between the modules. Preferably, the present invention provides for an article for establishing a web site wherein the at least one child module comprises a plurality of child modules having entry ports, and at least one of the child modules having at least one exit port, at least one of the child modules has an exit port linked to the entry port of another child module for communication of information between the modules; at least one exit port of at least one of the child modules has an exit port linked to the exit port of the base module.

Preferably the present invention provides for an article for establishing a web site wherein the at least one child module comprises a plurality of child modules, having a plurality of entry and exit ports, at least one of which child modules has a number of exit ports linked to an exit port of the base module. Preferably the present invention provides for an article for establishing a web site wherein the at least one child module comprises a plurality of child modules, having a plurality of entry and exit ports, at least one of which child modules has a number of entry ports linked to an entry port of the base module. Preferably the present invention provides for an article for establishing a web site wherein each module has at least one specialized function.

Preferably the present invention provides for an article for establishing a web site wherein the base module comprises a base store site module which has at least one entry port for communication with the internet and at least one exit port; the at least one exit port of the base module being available for linking with an exit port of a child module; the at least one child module being selected from the set comprising: a store front module, a shopping module, a customer service module, an information module, or an auction module. Preferably the present invention provides for an article for establishing a web site wherein an entry port to a module comprises a URL address, and an exit port comprises an instruction to call a URL address.

Viewed from another aspect the present invention provides an article comprising: a computer-readable information storage medium; programming means recorded on the medium for establishing: a hierarchically structured modular web site for linking to the internet, to provide access to the web site, comprising: a base module having an entry port for communication with the internet; at least one child module, contained by the base module, having an entry port for linking with the entry port of the base module; each module having at least one specialized function; each port being adapted for communication of information between modules linked therewith.

Preferably the present invention provides for an article for establishing a web site, comprising: at least one child module having an entry port for linking with the entry port of the base module and an exit port for linking with an entry port of another child module. Preferably the present invention provides for an article for establishing a web site comprising: at least one contained child module, comprising a termination module, having an exit port for linking to an exit port of an containing module. Preferably the present invention provides for an article for establishing a web site comprising: at least one contained child module, comprising a termination module, having an exit port for linking to another web site. Preferably the present invention provides for an article for establishing a web site comprising: at least one contained child module, comprising a termination module, has at least one entry port and no exit port.

Viewed from another aspect the present invention provides for an article comprising: a computer-readable information storage medium; programming means recorded on the medium for establishing: a hierarchically structured modular web site for linking to the internet, to provide access to the web site, comprising: a base module having an entry port for communication with the internet; and at least one contained child module contained within the base module, having an entry port for linking with the entry port of the base module and an exit port for linking with another contained child module.

Preferably the present invention provides for an article for establishing a web site, comprising: a base module having an entry port for communication with the internet and at least one exit port; and a plurality of contained child modules contained within the base module, having at least one entry port for linking with the entry port of the base module and exit ports for linking with at least one other contained child module and the exit port of the base module.

Preferably the present invention provides for an article for establishing a web site for linking to the internet, to provide access to the web site, comprising: a containing base module having an entry port for communication with the Internet and for communication with an entry port of an contained child module for communication therewith; a contained child module having an entry port for linking with the entry port of the base module and an exit port for linking with another contained child module; a further contained child module having an entry port for linking with an entry port of a containing module and at least one exit port for linking with another further contained child module; at least one contained child module comprising a termination module having only an entry port for linking with an containing module; each module having at least one specialized function; and each port being adapted for communication of information between modules linked thereby. Preferably the present invention provides for an article for establishing a web site wherein the termination module comprises a page module. Preferably the present invention provides for an article for establishing a web site wherein the termination module comprises a portal having a link to another web site.

A hierarchically structured modular web site in accordance with claim 126, wherein the at least one contained child module comprising a termination module having only an entry port for linking with an entry port of a containing module has an exit port for linking with a plurality of other modules.

Preferably the present invention provides for a hierarchically structured modular web site the termination module has an exit port for linking with the internet, in order to send information thereon.

Viewed from another aspect the present invention provides for an article comprising: a computer-readable information storage medium; programming means recorded on the medium for establishing: a hierarchically structured modular store web site for linking to the internet, to provide access by customers to the web site, comprising: a base store module having an entry port for communication with the internet for customer access and an entry port of at least one child module for communication therewith; at least one child module having an entry port for linking with the entry port of the base module; the at least one child module, contained by the base store module, comprising: a module selected from a set comprising: a store front module, a shopping module, a customer service module, and an information module; each port being adapted for communication of information between modules linked thereby to provide navigational access by a customer to child modules within the web site.

Preferably the present invention provides for an article for establishing a web site for linking to the internet, to provide access by customers to the web site, wherein the child modules comprise: a store front module, and a shopping module. Preferably the present invention provides for an article for establishing a web site wherein the store front module comprises a store front web page accessible by a customer; the store front web page being adapted to display an index of other modules in the web site accessible to the customer.

Preferably the present invention provides for an article for establishing a web site wherein the store front module comprises a store front web page accessible by a customer; the store front web page being adapted to display links to other modules in the web site accessible to the customer.

Preferably the present invention provides for an article for establishing a web site wherein the shopping area child module has exit ports linked to entry ports of child modules including a catalog section module and a checkout section module; the catalog section module having exit ports linked to entry ports of child modules including a catalog front page module; product page module; and category virtual page module; and the category virtual page module having exit ports linked to entry ports of child modules including a category page module, and a product list page module.

Preferably the present invention provides for an article for establishing a web site wherein the checkout section module has exit ports linked to entry ports of child modules including: shopping cart page; bill to page, ship to page, payment page, order submission page, and optionally, thank you page modules. Preferably the present invention provides for an article for establishing a web site in wherein the store web site includes a customer service area child module linked by its entry port to an exit port of the store web site; and the customer service area child module having exit ports for linking to entry ports of a log section and registration section child modules.

Preferably the present invention provides for an article for establishing a web site wherein the login section child module has an exit port linked to entry ports of a login page child, and forgotten password page modules. Preferably the present invention provides for an article for establishing a web site wherein the registration section child module has an exit port linked to an entry port of a registration page child module. Preferably the present invention provides for an article for establishing a web site wherein the store web site includes an information area (an about us area) child module having exit ports linked to entry ports of child modules, including privacy page, news page, and contacts page modules. Preferably the present invention provides for an article for establishing a web site wherein the base and child modules are implemented by business logic functions of a data processing server.

Preferably the present invention provides for an article for establishing a web site wherein the business logic functions are implemented by servlets or common gateway interface mechanisms and data storage for the web site store is maintained in a database of a database server. Preferably the present invention provides for an article for establishing a web site including an advertising child module linked to an exit port of the store web site and adapted to send promotional information customers contacting the store web site by means of a common gateway interface presented to the customers. Preferably the present invention provides for an article for establishing a web site wherein the advertising module is adapted to send promotional information to the customers based on information provided by the customers in viewing or selecting merchandise from the catalog section module. Preferably the present invention provides for an article for establishing a web site wherein a module includes at least one contained child module and the at least one contained child module include at least one contained child module. Preferably the present invention provides for an article for establishing a web site wherein a module includes at least one contained child module and the at least one contained child module include at least one contained child module, and at least one child module contains a termination module.

Preferably the present invention provides for an article for establishing a web site wherein a module includes at least one contained child module and the at least one contained child module include at least one contained child module, and at least one child module contains a termination module, the termination module having a link to another web site.

Viewed from another aspect the present invention provides for an article comprising: a computer-readable signal-bearing medium, wherein the medium is a modulated carrier signal, or a recordable data storage medium selected from the group consisting of magnetic, optical, biological and atomic data storage media, or wherein the signal is a transmission over the internet; means in the medium for establishing: a hierarchically structured store web site for use on the internet comprising: a base store site module having at least one entry port for communication with the internet; at least one child module of the base store site module having an entry port; and the entry port of the base store site module being linked to the entry port of the child module for communication between the base store site and the child module.

Preferably the present invention provides for an article for establishing a web site wherein the at least one child module has an entry port and an exit port. Preferably the present invention provides for an article wherein the at least one child module has at least one entry port and at least one exit port; and the base module has at least one entry port; at least one of the entry ports of the child is linked to at least one entry port of the base module.

Preferably the present invention provides for an article for establishing a web site wherein the at least one child module has at least one entry port and at least one exit port; the base module has at least one entry port and at least one exit port; and at least one of the entry ports of the child is linked to at least one entry port of the base module. Preferably the present invention provides for an article for establishing a web site wherein at least one of the entry ports, and at least one of the exit ports of the at least one child module are linked, respectively, to at least one of the base module's entry ports, and at least one of the base module's exit ports. Preferably the present invention provides for an article for establishing a web site wherein the base module has a plurality of entry ports, and at least some of the plurality of entry ports of the base module are linked to the entry port of the at least one child module.

Preferably the present invention provides for an article for establishing a web site wherein the at least one of child module has a plurality of exit ports, and at least some of the plurality of exit ports of the child module are linked to one exit of the base module. Preferably the present invention provides for an article for establishing a web site wherein at least one of the exit ports of the at least one child module is linked to at least one of the entry ports of another child module. Preferably the present invention provides for an article for establishing a web site wherein the base store site module has at least one entry port for communication with the internet; the at least one child module being selected from the set comprising: a store front page module, a shopping area module, a customer service area module, an information area module, or an auction area module.

Preferably the present invention provides for an article for establishing a web site wherein the base store site module has at least one entry port for communication with the internet and at least one exit port; and the at least one exit port of the base store site module being available for linking with an exit port of a child module.

Viewed from another aspect the present invention provides for an article comprising a computer-readable signal-bearing medium, wherein the medium is a modulated carrier signal, or a recordable data storage medium selected from the group consisting of magnetic, optical, biological and atomic data storage media, or wherein the signal is a transmission over the internet; means in the medium for establishing a hierarchically structured modular web site for linking to the internet, comprising: a base module having at least one entry port for communication with the internet; at least one child module, contained by the base module, having an entry port, the entry port of the at least one child module being linked with an entry port of the base module for communication between the base module and the child module.

Preferably the present invention provides for an article for establishing a web site for linking to the internet, comprising: a base module having at least one entry port for communication with the internet; at least one child module having an entry port and an exit port, the entry port of the at least one child module being linked with an entry port of the base module for communication between the base module and the child module. Preferably the present invention provides for an article for establishing a web site wherein the base module has an exit port; the exit port of the at least one child module being linked to the exit port of the base module.

Preferably the present invention provides for an article for establishing a web site wherein the at least one child module comprises a plurality of child modules, each having entry ports, and at least one of the child modules having at least one exit port, at least one of which child module has an exit port linked to the entry port of another child module for communication of information between the modules. Preferably the present invention provides for an article for establishing a web site wherein the at least one child module comprises a plurality of child modules having entry ports, and at least one of the child modules having at least one exit port, at least one of the child modules has an exit port linked to the entry port of another child module for communication of information between the modules; at least one exit port of at least one of the child modules has an exit port linked to the exit port of the base module. Preferably the present invention provides for an article for establishing a web site wherein the at least one child module comprises a plurality of child modules, having a plurality of entry and exit ports, at least one of which child modules has a number of exit ports linked to an exit port of the base module.

Preferably the present invention provides for an article for establishing a web site wherein the at least one child module comprises a plurality of child modules, having a plurality of entry and exit ports, at least one of which child modules has a number of entry ports linked to an entry port of the base module. Preferably the present invention provides for an article for establishing a web site wherein each module has at least one specialized function.

Preferably the present invention provides for an article for establishing a web site wherein the base module comprises a base store site module which has at least one entry port for communication with the internet and at least one exit port; the at least one exit port of the base module being available for linking with an exit port of a child module; the at least one child module being selected from the set comprising: a store front module, a shopping module, a customer service module, an information module, or an auction module.

Preferably the present invention provides for an article for establishing a website wherein an entry port to a module comprises a URL address, and an exit port comprises an instruction to call a URL address.

Viewed from another aspect the present invention provides an article comprising: a computer-readable signal-bearing medium, wherein the medium is a modulated carrier signal, or a recordable data storage medium selected from the group consisting of magnetic, optical, biological and atomic data storage media, or wherein the signal is a transmission over the internet; means in the medium for establishing: a hierarchically structured modular web site for linking to the internet, to provide access to the web site, comprising a base module having an entry port for communication with the internet; at least one child module, contained by the base module, having an entry port for linking with the entry port of the base module; each module having at least one specialized function; and each port being adapted for communication of information between modules linked therewith.

Preferably the present invention provides for an article for establishing a web site comprising: at least one child module having an entry port for linking with the entry port of the base module and an exit port for linking with an entry port of another child module. Preferably the present invention provides for an article for establishing a web site comprising: at least one contained child module, comprising a termination module, having an exit port for linking to an exit port of an containing module. Preferably the present invention provides for an article for establishing a web site comprising: at least one contained child module, comprising a termination module, having an exit port for linking to another web site.

Preferably the present invention provides an article for establishing a web site comprising: at least one contained child module, comprising a termination module, has at least one entry port and no exit port.

Viewed from another aspect the present invention provides for an article comprising: a computer-readable signal-bearing medium, wherein the medium is a modulated carrier signal, or a recordable data storage medium selected from the group consisting of magnetic, optical, biological and atomic data storage media, or wherein the signal is a transmission over the internet; means in the medium for establishing: a hierarchically structured modular web site for linking to the internet, to provide access to the web site, comprising: a base module having an entry port for communication with the internet; and at least one contained child module contained within the base module, having an entry port for linking with the entry port of the base module and an exit port for linking with another contained child module. Preferably the present invention provides for an article for establishing a web site comprising: a base module having an entry port for communication with the internet and at least one exit port; a plurality of contained child modules contained within the base module, having at least one entry port for linking with the entry port of the base module and exit ports for linking with at least one other contained child module and the exit port of the base module.

Preferably the present invention provides for an article for establishing a web site for linking to the internet, to provide access to the web site, comprising: an containing base module having an entry port for communication with the internet and for communication with an entry port of an contained child module for communication therewith; a contained child module having an entry port for linking with the entry port of the base module and an exit port for linking with another contained child module; a further contained child module having an entry port for linking with an entry port of a containing module and at least one exit port for linking with another further contained child module; at least one contained child module comprising a termination module having only an entry port for linking with an containing module; each module having at least one specialized function; and each port being adapted for communication of information between modules linked thereby.

Preferably the present invention provides for an article for establishing a web site wherein the termination module comprises a page module. Preferably the present invention provides for an article for establishing a web site wherein the termination module comprises a portal having a link to another web site. Preferably the present invention provides for an article for establishing a hierarchically structured modular web site, wherein the at least one contained child module comprising a termination module having only an entry port for linking with an entry port of a containing module has an exit port for linking with a plurality of other modules.

Preferably the present invention provides an article for establishing a hierarchically structured modular web site wherein the termination module has an exit port for linking with the internet, in order to send information thereon.

Viewed from another aspect the present invention provides for an article comprising a computer-readable signal-bearing medium, wherein the medium is a modulated carrier signal, or a recordable data storage medium selected from the group consisting of magnetic, optical, biological and atomic data storage media, or wherein the signal is a transmission over the internet; means in the medium for establishing: a hierarchically structured modular store web site for linking to the internet, to provide access by customers to the web site, comprising: a base store module having an entry port for communication with the internet for customer access and an entry port of at least one child module for communication therewith; at least one child module having an entry port for linking with the entry port of the base module; the at least one child module, contained by the base store module, comprising: a module selected from a set comprising: a store front module, a shopping module, a customer service module, and an information module; and each port being adapted for communication of information between modules linked thereby to provide navigational access by a customer to child modules within the web site.

Preferably the present invention provides for an article for establishing a web site for linking to the internet, to provide access by customers to the web site, wherein the child modules comprise: a store front module, and a shopping module. Preferably the present invention provides for an article for establishing a web site wherein the store front module comprises a store front web page accessible by a customer; and the store front web page being adapted to display an index of other modules in the web site accessible to the customer.

Preferably the present invention provides for an article for establishing a web site wherein the store front module comprises a store front web page accessible by a customer; and the store front web page being adapted to display links to other modules in the web site accessible to the customer. Preferably the present invention provides for an article for establishing a web site wherein the shopping area child module has exit ports linked to entry ports of child modules including a catalog section module and a checkout section module; the catalog section module having exit ports linked to entry ports of child modules including a catalog front page module; product page module; and category virtual page module; and the category virtual page module having exit ports linked to entry ports of child modules including a category page module, and a product list page module.

Preferably the present invention provides for an article for establishing a web site wherein the checkout section module has exit ports linked to entry ports of child modules including: shopping cart page; bill to page, ship to page, payment page, order submission page, and optionally, thank you page modules.

Preferably the present invention provides for an article for establishing a web site wherein the store web site includes a customer service area child module linked by its entry port to an exit port of the store web site; and the customer service area child module having exit ports for linking to entry ports of a log section and registration section child modules.

Preferably the present invention provides for an article for establishing a web site wherein the login section child module has an exit port linked to entry ports of a login page child, and forgotten password page modules. Preferably the present invention provides for an article for establishing a web site wherein the registration section child module has an exit port linked to an entry port of a registration page child module. Preferably the present invention provides for an article for establishing a web site wherein the store web site includes an information area (an about us area) child module having exit ports linked to entry ports of child modules, including privacy page, news page, and contacts page modules.

Preferably the present invention provides for an article for establishing a web site wherein the base and child modules are implemented by business logic functions of a data processing server.

Preferably the present invention provides for an article for establishing a web site wherein the business logic functions are implemented by servlets or common gateway interface mechanisms and data storage for the web site store is maintained in a database of a database server.

Preferably the present invention provides for an article for establishing a web site including an advertising child module linked to an exit port of the store web site and adapted to send promotional information customers contacting the store web site by means of a common gateway interface presented to the customers. Preferably the present invention provides for an article for establishing a web site wherein the advertising module is adapted to send promotional information to the customers based on information provided by the customers in viewing or selecting merchandise from the catalog section module. Preferably the present invention provides for an article for establishing a web site wherein a module includes at least one contained child module and the at least one contained child module include at least one contained child module.

Preferably the present invention provides for an article for establishing a web site wherein a module includes at least one contained child module and the at least one contained child module include at least one contained child module, and at least one child module contains a termination module. Preferably the present invention provides for an article for establishing a web site wherein a module includes at least one contained child module and the at least one contained child module include at least one contained child module, and at least one child module contains a termination module, the termination module having a link to another web site.

The ports advantageously can be adapted for communication of information between modules linked thereby to provide navigational access by a user or customer to child or other modules within the web site or to external web sites. Some modules can be adapted to display an index of other modules in the web site, or to display links to other modules in the web site accessible to the customer.

### BRIEF DESCRIPTION OF THE DRAWINGS

The invention will now be described by way of example only, with reference to the accompanying drawings, in which:

FIG. 1 depicts a typical interaction between a client web browser and a commerce server;

FIG. 2 depicts a logical view of web navigation;

FIG. 3 depicts a layered architecture style for web applications;

FIG. 4 depicts a containment hierarchy of a site;

FIG. 5 depicts encapsulation of components;

FIG. 6 depicts a typical page skeleton with a page frame occupying the outer perimeter of the page;

FIG. 7 depicts side-trip link implementation;

FIG. 8 depicts guarded links and a guarding section;

FIG. 9 depicts a store web site base component and contained components;

FIG. 10 depicts a shopping area;

FIG. 11 depicts a catalog section;

FIG. 12 depicts a checkout section;

FIG. 13 depicts a customer service section;

FIG. 14 depicts a login section;

FIG. 15 depicts a registration section;

FIG. 16 depicts the hierarchical structure of a store web site

### DETAILED DESCRIPTION OF A PREFERRED EMBODIMENT OF THE PRESENT INVENTION

Web Navigation and the Web Programming Model

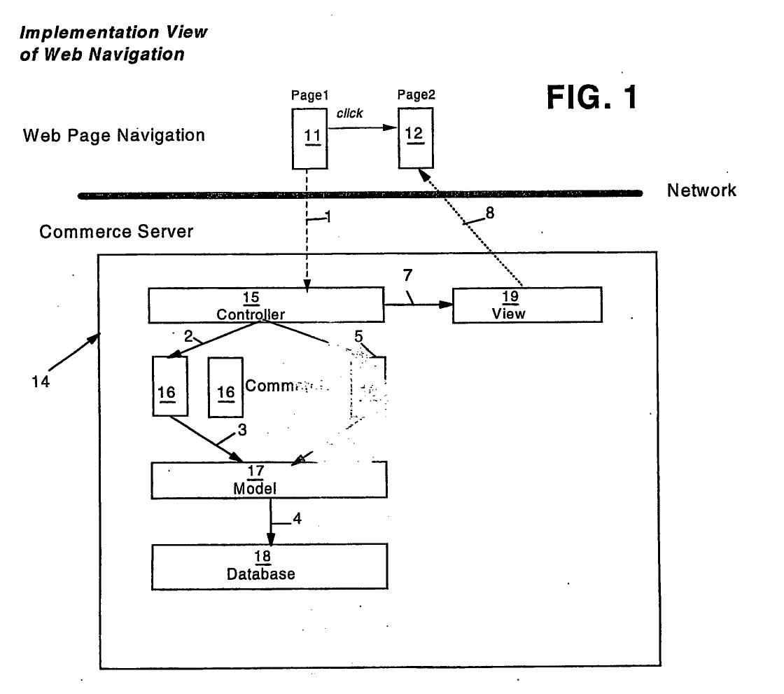

A typical Web programming model is usually based on the Common Gateway Interface (CGI) or Servlet programming interface. FIG. 1 depicts a typical interaction relationship between a client web browser that can be used by a visitor or user and a corresponding commerce web site server 14. While at a selected page 11 (“e.g. Page 1”) of the web site, a visitor clicks on a selected HTML link, generating a HTTP request which triggers related activities on the server 14. Typically, as depicted the commerce web site server has a controller 15 ready to receive and process the (HTTP) request. Assuming the visitor is allowed to proceed, the controller 15 may delegate the execution of business logic for the web site to a sequence of commands 16 to be executed. Each command 16 represents some business logic and it may access the model 17 which represents data from the (relational) database 18. After the execution of the business logic, the controller will invoke and pass data into the view 19 which returns a new page 12 (“Page 2”), giving the user the impression of site navigation through the site.

In this model, the server provides a set of “subroutines” as specified by controller URLs with arguments supplied as name-value pairs. Each subroutine may be called (remotely) from pages displayed on a visitor's browser. The CGI or servlet interface provides a mechanism for (remote) subroutine calls, so that the appropriate subroutine will be called to trigger the appropriate page transition as required, as will be understood by those skilled in the art.

Logical View of Web Navigation

While it is instructive for a programmer to describe the process of how a request is processed by a commerce server, the use of a URL to call a “subroutine” to execute some business logic which eventually leads to the target page most likely masks the real intention of the designer of the site. From the point of view of some persons skilled in the art it is unfortunate that visitor navigation is hidden behind the complexity of the execution of business logic.

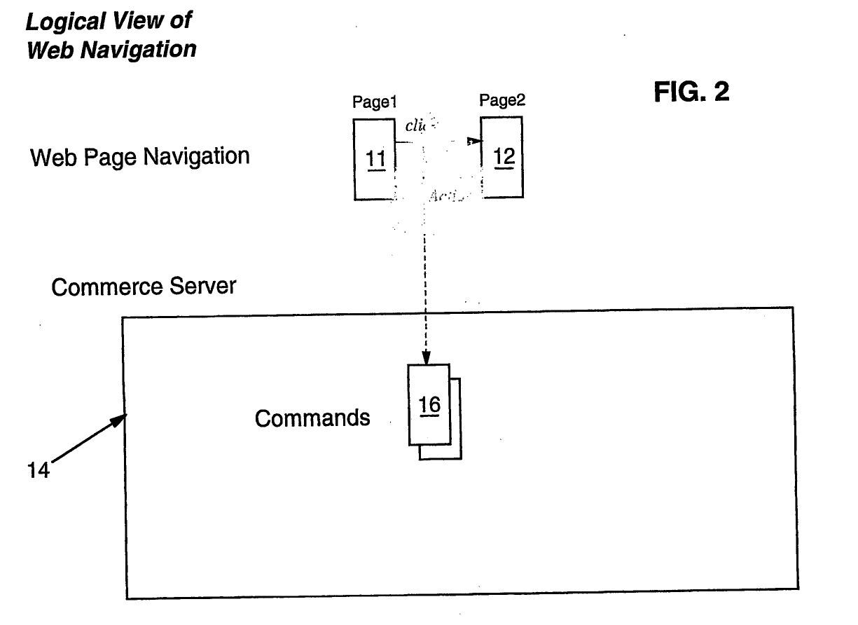

A site designer might prefer to turn the situation around, at least at the logical level, and think of entering of a Web site in a similar manner to entering a (physical) place. FIG. 2 depicts a logical view of web navigation. The visitor may visit different places in the site by following links provided for that purpose. For instance, the visitor might move from one page, 11, to another page, 12, by clicking on a link. While the visitor moves from one place to another and examines items along the way, some business logic may be executed using commands 16 in the server 14. The logical view we discuss is similar in spirit to the original purpose of HTML links, i.e. as a method of “travelling” cyber space. With this logical view, the emphasis is on defining places (including the items to be displayed in those places) and movements or transitions from place to place. Actions, which are executed as business logic in the server, may be associated with the transitions. This view will be the base for the methodology in creating the site architecture of the invention.

Designing an e-commerce site can be considered as designing a virtual place where a customer may visit and participate in commercial transactions. A site architecture can then be represented by a blueprint describing the relevant places in the site and the paths of navigation from one place to another. This is similar to how an architect would describe the design of a building.

Site Architecture and Commerce Server Architecture

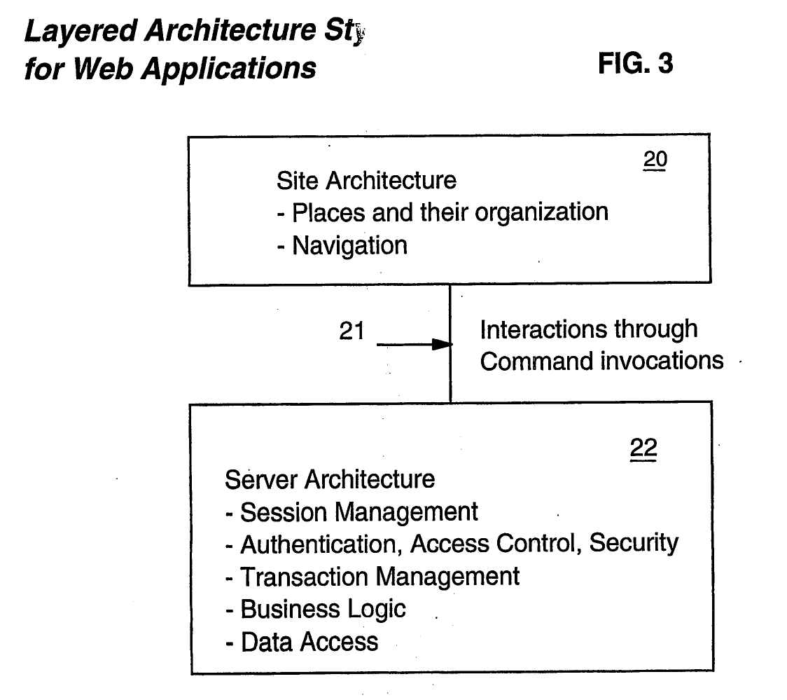

In order to obtain a complete model of a Web application, we should provide both site and server architectures, as depicted in FIG. 3. It is also beneficial to separate the two domains (site, 20 and server, 22) as each serves a specific but different purpose. Site architecture relates to navigation, i.e. places visitors may visit, how they navigate the site, and what action should be associated with their navigation. Server architecture relates to session management, authentication, access control, security, transaction management, business logic, and data access, among others. There may be common functions or facilities which are features of both site and server architectures.

The logical view of the architecture can then be presented in a layered architecture style, in which site architecture, 20 invokes required actions through commands, 21 provided by the server architecture, 22 layer. The Command Pattern referred to in reference [3] may be used to provide this service to the site architecture layer. The server architecture layer, 22 may be modeled using the well-known methodology such as UML [4] or Software Architecture [5]. The methodology of one aspect of the invention for creating the site architecture i's described below.

Elements of Site Architectures

Introduction

Currently, the most popular technique for expressing the design and architecture of e-commerce Web sites seems to use flowchart diagrams to describe the pages and the navigation flows between pages. While using a flowchart is an effective way for describing the structure of a small site, it does not show the modularity of the site and it may become difficult to understand and maintain the site if and when it gets larger. Another popular technique is to use a “storyboard” technique to describe the site. The storyboard may show the flow (and the look and feel) of the site by navigating through it, but it does not readily reveal the overall structure of the site. What is an architecture? In the young field of Software Architecture, there is no single accepted definition of the term [5, 6]. The precise definition of Site Architecture may also be as difficult to define. There seems to be a consensus that an architecture, at the minimum, should describe components, connectors, and constraints.

Components may be described in a hierarchical fashion with their specific purposes or functions. In Site Architecture, components would represent (virtual) places in a site. Connectors represent the interrelationships among the components. In Site Architecture, connectors would represent the navigation from one place to another. Constraints may specify containment relationships among the components and how connectors may be placed between components.

Hierarchical Decomposition into Components

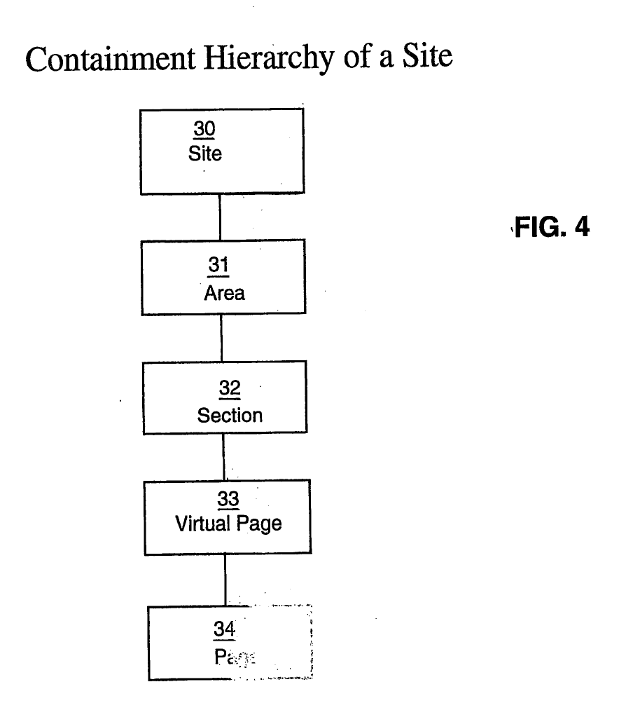

Referring to FIG. 4 in order to describe one aspect of the invention component hierarchy will be introduced, starting with the site component, 30 as the root. The site component, 30 is decomposed into smaller subcomponents called Areas, 31. An area, 31 is in turn decomposed into smaller subcomponents called Sections, 32, which is, in turn, decomposed into smaller subcomponents called Virtual Pages, 33, which contain one or more Pages, 34. This decomposition forms a containment hierarchy rooted at the site component, 30. Note that each component in the hierarchy represents an abstraction of a virtual place used for a specific purpose. In the e-commerce context, a site may be decomposed into a Shopping area and a Customer Service area. The shopping area is designed for the users or customers of the site to do shopping, while the customer service area is designed to handle different customer needs such as order inquiries, registrations, profile updates, etc.

In general, a component may contain one or more components of any type of lower hierarchies. For example, a particular site component may contain three subcomponents: a front page, a shopping area, and a customer service area. Note that the methodology itself is independent of the depth of the hierarchy. More levels of hierarchy could be introduced if that necessary. This will, of course, introduce additional complexity. From our experience, a five level hierarchy is sufficient in many circumstances.

Component Interface: Encapsulation via Entry and Exit Ports

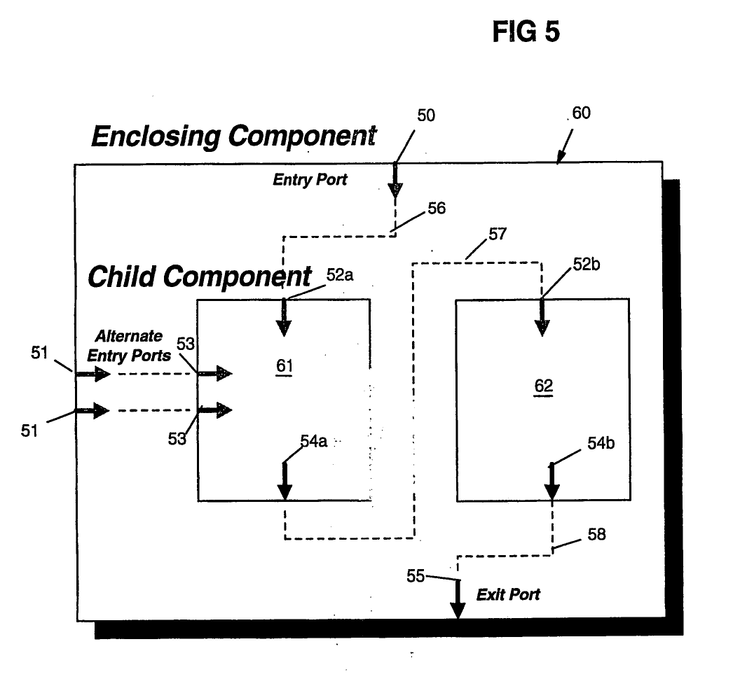

FIG. 5 depicts components of a web site in accordance with the invention herein. Each component of a web site must be reachable or addressable by navigation. The main web site itself is reachable through its external URL. The same can be said about the other components (such as areas, sections, and pages) within the site. Sometimes, we may arrive at the same component through different navigation. The components, 60, 61, 62 illustrated have entry ports 50, 51, 52a, 52b which represent gates for entering those components, as may be seen from FIG. 5. A component may have one or more entry ports; it may be entered only through these ports. For instance, parent or containing component 60 has entry port 50 and alternate entry ports 51; child component 61, contained by component 60 has entry ports 52a, and 53.

A component may also lead to another component by navigation. For example, an HTML link on a page may lead to another component in the same site. The invention herein provides exit ports for components. An exit port represents the starting point of a navigation to another component. Note that an exit port is not the same as an HTML link (with a URL). An exit port represents one or more HTML links leading into the same component. All URLs in those links, which are represented by an exit port, should have the same URL, differing perhaps in the values of name value pairs for those URLs. A port associated with a component can be thought of as a subroutine or interface definition. This definition would include the name of the port and the definitions of each argument of that port. This port can be referred by some HTML link by specifying the port name and its arguments by a URL and the corresponding name-value pairs as the actual arguments.

Conceptually, the entry and exit ports of a component could be said to define the interface of that component. Each component, which represents a virtual place, is encapsulated (for instance, components 61 and 62 are contained by component 60) and it can only be entered and exited via its entry and exit ports, respectively. The interface of a component defines how that component can be connected with other sibling components (component 61 is connected by its exit port 54a to component 62 by its entry port 52b) and its containing component (contained child component 61 is connected by its entry port 52a to containing component 60 by its entry port 50, whereas contained child component 62 is connected by its exit port 54b to the exit port 55 of containing component 60. These connections can be realized without knowing the details of the components as long as the connecting ports are compatible. For the purposes of this invention a source port is considered to be compatible with a target port if that source port supplies all the arguments expected by that target port. Beside being encapsulated, a component also represents an abstraction as defined by its purpose. That abstraction will be realized by the implementation of that component. There may be different implementations for a component of a particular interface.

Navigation Links

Navigation plays an important part of a site design. It makes the site dynamic and responsive to visitor interactions. Components may be connected by navigational links via their entry and exit ports. There are three kinds of links that can be created within a component (these are illustrated in FIG. 5):
1. Entry links: These are links connecting entry ports of a component to the entry ports of the subcomponents. Multiple entry ports of a component may be connected to a single entry port of the subcomponent. Entry link 56 connects the entry port, 50 of component, 60 to child component 61 by its entry port 52a.
2. Exit links: These are links connecting exit ports of the subcomponents to the exit ports of the component. Multiple exit ports of the subcomponents may be connected to a single exit port of the component. Exit link 58 connects contained component 62 by its exit port 54b to the exit port, 55 of containing component 60.
3. Inter-component links: This link connects an exit port of a subcomponent to an entry port of a sibling subcomponent. Intercomponent link 57 connects exit port 54a of subcomponent 61 to entry port 52b of sibling component 62.
   Component Template: Separation of Component Implementation and Navigation Links

Beside being specified by its interface, a component is also specified, at the next level of detail, by the subcomponents it contains. Note that these subcomponents are also specified by their interfaces. At this level, one can draw the navigation links by connecting the ports as described earlier. The resulting diagram defines a component template (similar to a circuit board), representing the next level of detail toward achieving a complete implementation of that component. Note that only the interfaces of the subcomponents are needed in order to create a component template.

Using this approach, we separate the problem of implementing of a subcomponent from the problem of defining the navigation links. All a subcomponent implementation can see from within is its exit ports. The subcomponent implementation does not know and does not need to know where the exit ports leads. That is handled by the containing component template. The template depends on the interfaces of the subcomponents for the link connections, but it does not concern itself with the detailed internal implementation of the subcomponents, The use of component templates advantageously should facilitate the reuse of a component design and convey the flexibility of changing the implementation of a (sub)component without affecting the rest of the site.

Virtual Page Component

From our experience building e-commerce sites, there is a need in some cases to present different pages to the same URL request depending on the state of some object relevant to the family of pages concerned. For example, when trying to display a product category page it is sometimes necessary to display the subcategory list and at other times to display products belonging to that product category. This may depend on whether that product category has subcategories or not. If it does, the list of subcategories will be displayed, otherwise the list of products in that category will be displayed. So, one may say that depending on the state of the product category being considered, a different page may be returned to the browser. In order to have the flexibility of presenting the appropriate page depending of the state of some related object, the concept of virtual page is now introduced.

Conceptually, a virtual page can be considered to have multiple forms and may dispatch the appropriate page depending on the state of some object related to that virtual page. When visited, a virtual page will polymorphically present the appropriate page from a set of pages it may contain. A virtual page will have some input ports which will polymorphically lead to the input ports of its subcomponent (i.e. page component). Its output ports will be the union of the output ports of the pages it contains. An area or section may contain some virtual pages only if the need arises. Otherwise, it is better for that area or section to only have actual pages.

Page Component

The page component is the presently the lowest level component in the containment hierarchy. The possibility of extending the hierarchy by breaking up the page into “page fragments” can be considered in the future. Page components are typically implemented as Web pages with dynamic content using technology such as JavaServer Pages™ (JSP) or even as static HTML pages.

At the minimum a page should be specified by its input ports, exit ports and the data that makes up its dynamic content. This data is usually retrieved from a database and is included in the presentation of that page. It is convenient to represent this data by one or more databeans, each representing a (recursive) data structure for display on that page. It is expected that these databeans are created as a result of the execution of a command which retrieves the appropriate data from the database. The association between a page and its databeans can be considered as a data contract on that page. With this data contract, the creative designer and the programmer may work in parallel in implementing the page and the associated logic. The static content and the presentation of a page is not important for the purposes of the discussion of this invention, but it is important in the success of the final production Web site.

Page Frame and Page Content

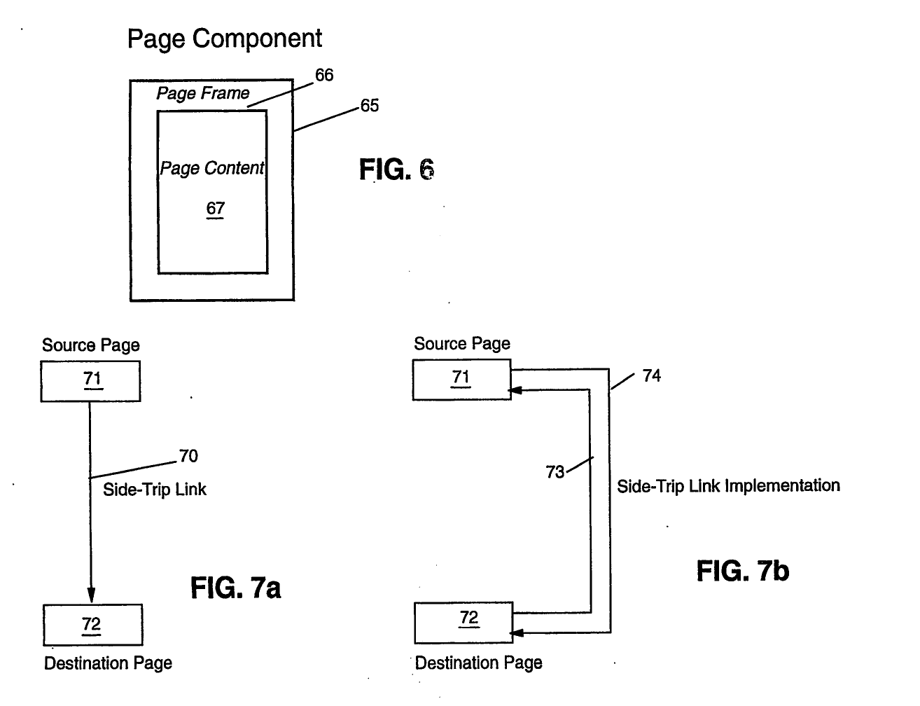

Referring to FIG. 6 a useful approach to providing a consistent presentation across a site, a page, 65 may be divided into two parts: the page frame, 66 and the page content, 67. The consistent presentation of the page frame, 66 is intended to bring familiarity while navigating the site. Beside for presentation purposes, It typically contains links or convenient shortcuts to other places in the site, and perhaps a simple input field for a search. For our modeling purpose, the exit ports, the input and output databeans associated with the frame are of interest. The specific presentation aspect of the frame is ignored at this level.

The separation of the page frame from the page content is motivated by the problem of providing consistent presentation across the whole site. If the frame is the same for every page in the site, we can factor out that frame and make it as a property of the site component. If the frame is different for every page, then it should belong to the page component. We could also assign the frame to an area or section component as a compromise. It is up to the site architect to decide which model is the most appropriate for the site.

Abstractions and Patterns in Site Architecture.

The previous section describes the basics in the methodology and notations for modeling site architectures: hierarchical components and navigation links. In order to improve the flexibility of the model, esp. in modeling basic e-commerce common practices, we need to introduce useful concepts based on abstractions and patterns into the model. This section introduces some of the concepts that we have observed so far. It is not meant to be a complete list of such concepts. First, we will introduce a simple abstraction of shoppers and their authentication. We then model the behaviour of forms commonly found in e-commerce sites by abstracting the behaviour of such forms. The remaining concepts are based on abstracting navigational patterns commonly found in e-commerce sites.

Shoppers

Shoppers are the main actors in our model of Site Architecture. For the purpose of supporting express checkout and registration, each shopper is associated with a state representing authentication. Upon entering the site, the shopper is in “guest” state. In this state, the shopper has not been authenticated yet but is free to see the catalog available in the site. During the shopping process, the shopper may be asked for authentication of identity by filling in a login form. Once authenticated, the state of that shopper will be changed to “authenticated” state. Note that authentication requires that the shopper has been registered previously. Depending on the complexity or security of the site, a more complex authentication state may be introduced in order to support the site policy. For our purpose, a simple binary state is sufficient.

Simple Forms

Forms are commonly used to collect information from the shoppers during the shopping process. Login and Registration forms are examples of such pages. Here we would like to specify the abstract behaviour of form pages used in the Site Architecture. Every form page will have at least two exit ports: Submit and Cancel. The Submit port will bring the shopper to the destination of that exit port if there is no error encountered during the processing of the form data. In the case of error, the same form page can be presented to the shopper with appropriate error message. So, every form page will be associated with at least two databeans: form databean and error databean. Of course the error databean may be empty and no error message will be displayed on that page if it is empty a common initial state. The error bean is usually created and filled after the processing of the form. Unless explicitly specified, the Cancel exit port will bring the shopper to the page of origin. This is the behaviour of form pages we use for the rest of this example. With this abstraction in mind, we will not show the loop representing error paths in the following diagram to simplify the model.

Side-Trip Links

FIG. 7 (composed of 7a and 7b) depicts side-trip link implementation. A side trip is a navigation from one source page to another (destination) with the intent of returning to the source page immediately. This pattern can be observed in a shopping cart page on most sites. The shopping cart usually contains a list of line items of interest to the shopper. Each line item typically contains a brief description of that item. Just in case the shopper wishes to see a complete description of that item, a link from each line item to the corresponding product page (containing the full description of that item) is usually provided. This navigation link implements a side trip as the shopper is expected to return to the shopping cart page after reviewing the full description of that line item. Also, a link for returning to the source page may be provided on the destination page. The return URL to the source page must be specified in the definition of a side trip link.

Referring to FIG. 7 there is depicted details of a side-trip link which is implemented as two regular links. In the architecture diagram, for simplicity there will be just one link (of type “side-trip”) defined. In FIG. 7a a side-trip link 70 from source page 71 to destination page 72 is indicated. FIG. 7b illustrates the implementation of this side-trip link 70 by link 74 from the source page 71 to the destination page 72, and return link 73.

Guarded Links and Guarding Section

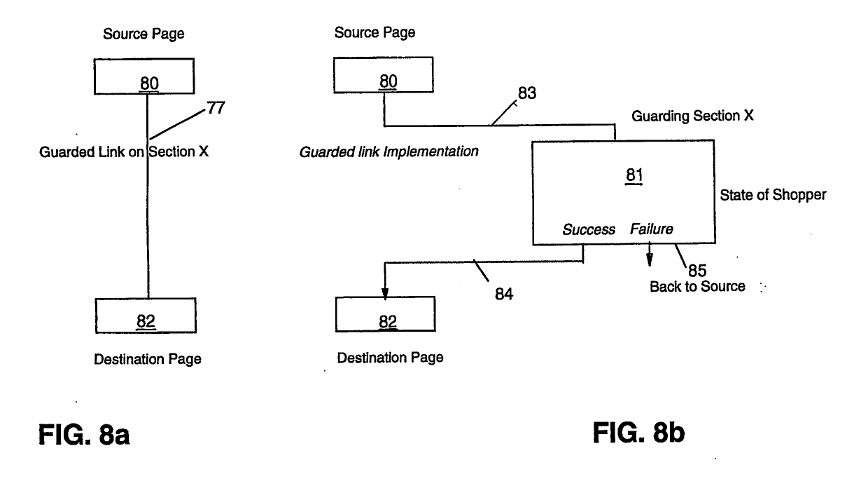

FIG. 8 (composed of 8a and 8b) depicts the implementation of a guarded link. Another common pattern is that some navigation must go through a guard (implemented as a guarding section) before the desired destination can be visited. Referring to FIG. 8a it can be seen that destination page 82 is guarded by link 77 to control access from source page 80. A guard is used when a site requires a shopper or other user to fill in a form (such as a login or registration form) before continuing. Typically, the shopper is prompted to fill in a form or forms when the destination link is clicked. If the forms are successfully completed, the shopper will be directed to the destination. Otherwise, the shopper may be required to fix any mistakes on the same form. Of course, the shopper may (at anytime) cancel this process (sometimes referred as a failure) and go back to the page of origin. This guarding section 81 is a helper section containing helper pages acting as a guard that is useful, to enforce certain policy of the site. The guarding section is typically used as a checkpoint to collect some information before the desired destination can be visited. As the same guarding section may be used in different locations in the site, their success/failure exit ports are not statically associated with any particular target ports. Instead, the target port will be provided at run-time by the using a guarded link. This makes the guarding section reusable for different occurrences of guarded links within a web site, for instance. Each guarded link is associated with the corresponding guarding section.

Going through the guarding section successfully will ultimately change the state of some objects associated with that section. Usually, it is the state of the shopper that will be affected by going through these sections.

Conditional Guarded Links

Traversing guarded links will always lead to the corresponding guarding section, regardless how many times the shopper has passed this section successfully earlier. There are cases when it is sufficient for the shopper to pass through the gate just once. Authentication is an example of such a case. Shoppers need to be authenticated just once while visiting the site. This is the motivation for introducing conditional guarded link. Traversing a conditional guarded link will bring the shopper to the guarding section if the shopper has not successfully passed that section before (as the shopper state indicates). Passing this section successfully will bring the shopper to the intended destination. Failure will bring the shopper back to the page of origin. If the shopper has passed this section before as the shopper object indicates, the shopper can go directly to the destination.

Referring to FIG. 8b it may be seen that a shopper attempting to reach destination page 82 from source page 80 will be taken by link 83 to guarding section X, in this case, a login section 81 which verifies the state of the shopper. If the shopper is authenticated then link 84 connects the shopper to destination page 82, if not, then the shopper is guided, 85, back to the source.

An Example A Simple Retail Store

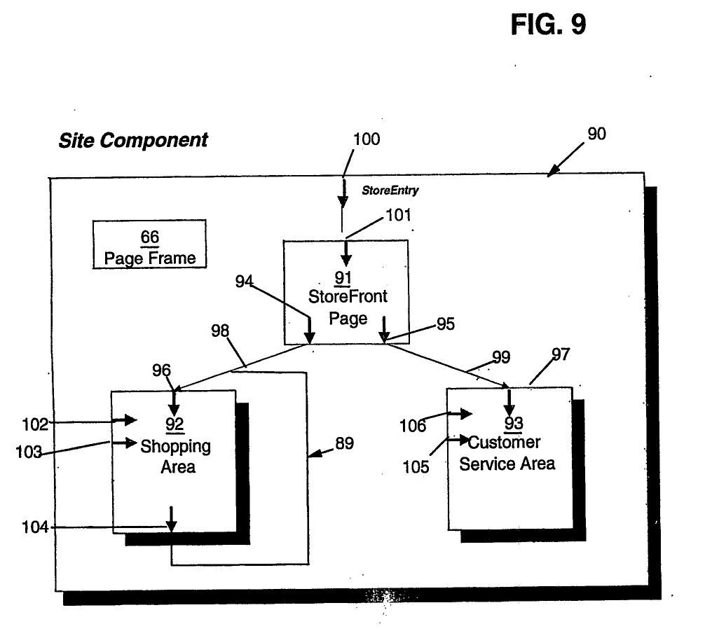

This section illustrates a simple retail store using the methodology of the invention as described in the previous sections. Referring to FIG. 9, we start with the site component of this simple example.

Site Component

The interface of the site component, 90 has one entry port, 100, specifying how the site should be entered. The site is composed of three subcomponents: Store Front page, 91, Shopping area, 92, and Customer Service area, 93. The store front page, 91, welcomes visiting shoppers to the site, and introduces links to the other two areas. Note that some site does not have a separate store front page, as it may be combined with the first page of a shopping area. As may be readily understood, the shopping area, 92, is the place where the shoppers find and buy products from the store. The customer service area, 93, may be used to provide useful services for shoppers such as login and registration.

The entry port, 100 of the site is linked or connected to the entry port, 101 of the store front page. This entry link is used to describe how control should be passed from the containing component to the subcomponent. From the front page, 91 a shopper may enter the Shopping area, 92 or Customer service area, 93 through the well-defined exit ports, 94, and 95, respectively of the front page, 91. Of course, we could have more than two exit ports on this front page, but only two are used in this simple example. The exit ports, 94, 95 in the page are connected to the respective entry ports, 96, 97 of the corresponding areas. When a shopper finishes the shopping process in the shopping area, the shopper can be brought back to the shopping area as depicted by the loop 89, in this implementation, although other possibilities exist. At this architectural level, only the interfaces of the subcomponents and the links among the components are specified. As such, FIG. 9 can be considered as a template for this simple store.

Page Frame

In this simple example, we assume that the page frame, 66 is owned by the Site component. This implies that every page in the site will have the same page frame. The page frame itself will advantageously contain shortcuts (represented by exit ports) to Home or Store Front page, Shopping Area, Shopping Cart, Checkout, and Customer Service. Here, we choose not to have any databean associated with this simple page frame.

Store Front Page

Assuming that we separate the page frame from the page content, the interface of the store front page is specified by one entry port, 101 and two exit ports, 94, and 95 leading to corresponding areas. This page can be associated with one databean representing the store information which is to be displayed on that page. This databean is produced by the execution of the appropriate command on the server.

Shopping Area

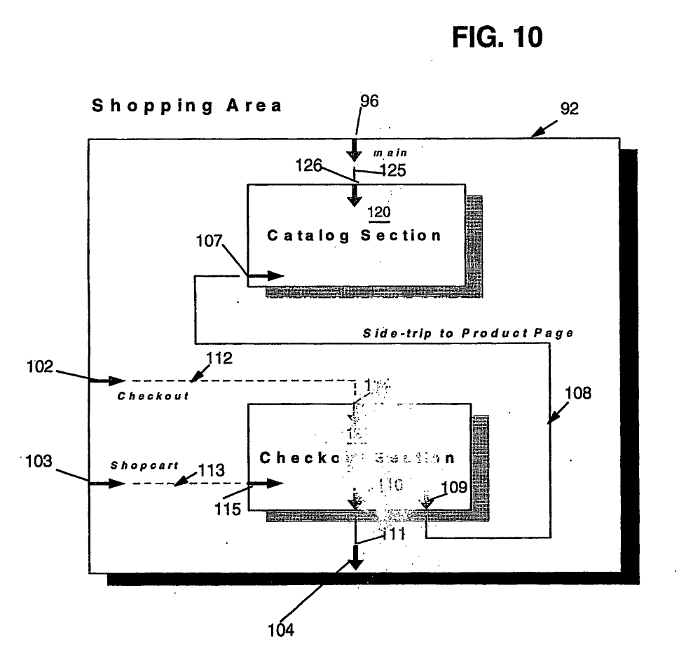

The shopping area, 92 as depicted with more detail in FIG. 10, defines three entry ports: main entry port, 96, checkout entry port, 102, and shopcart entry port, 103. The main entry, 96 is used for entering the area under normal shopping flow. The other two entry ports are alternate entry ports for entering the area with a specific destination in mind. As the name suggests, checkout entry port, 102 is used as a shortcut to enter the checkout process in the shopping area. Shopcart entry port, 103 is used as a shortcut for shoppers to examine the content of the shopping cart. Typically, these two alternate ports are used by a navigation bar implemented in the page frame.

This area is composed of two sections: Catalog section, 120 and Checkout section, 121. As the names suggest, the Catalog section, 120 is the place to find the products from the store's catalog. The Checkout section, 121 is the place for the shopper to complete the buying process. The main entry port, 96 leads (by link, 125) into the catalog section, 120 (by its entry port 126) and this is what is expected under normal shopping flow. The checkout entry port, 102 leads by link 112 to the checkout section, 121 and the shopcart entry port, 103 leads by link 113 to the shopcart entry port, 115 of the checkout section. The checkout section should be entered in this embodiment by following the link provided in the navigation bar in the page frame. At the end of the shopping process, the embodiment depicted will bring the shopper back to the shopping area. We also provide a side-trip link, 108 from the checkout section, 121 to the catalog section, 120 for the purpose of giving shopper access to the full description of the line item of interest in the shopping cart should the shopper so choose. Again, FIG. 10 can be considered as a template for a shopping area.

Catalog Section

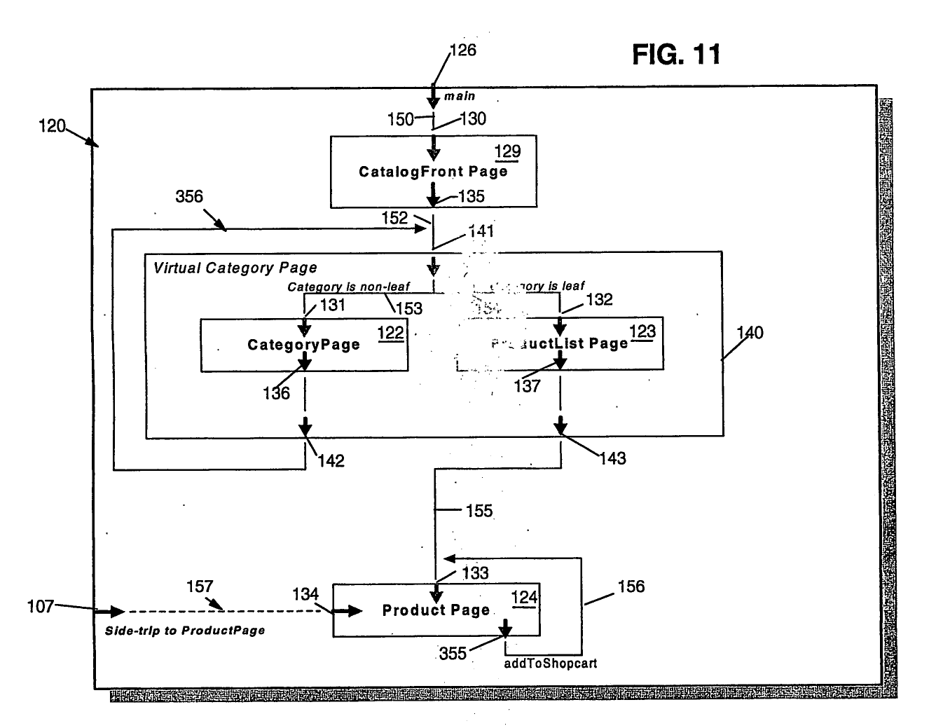

This section which is depicted in FIG. 11, has a main entry port, 126 and an entry port, 107 for side-trips to the product page, 124. This simple catalog section, 120 allows shoppers to find products of interest by performing product category drill-down. The first page when entering this section via the main entry is the catalog front page, 129. This page welcomes shoppers to the catalog of the store. Here a list of top product category may be displayed. In this case the databean associated with the top category will be part of the specification of this page. From here, shoppers may follow links leading to the subcategories pages.

From the catalog front page, shopper will be directed to a virtual page for navigating through the catalog. This virtual page 140 will polymorphically display either the (sub)category page, 122 consisting of a list of subcategories or the product list page, 123 consisting of a list of products in that category.

Ultimately the navigation will lead to the product page, 124 where a full description of the product is displayed. On this page, there is usually provided a button which allows a shopper to add that item into the shopping cart. In this simple example, we choose to remain on the same page after an item is added to the shopping cart. To proceed to checkout, the shopper may click on the checkout link presented on the navigation bar which is part of the page frame (these are not shown).

Checkout Section

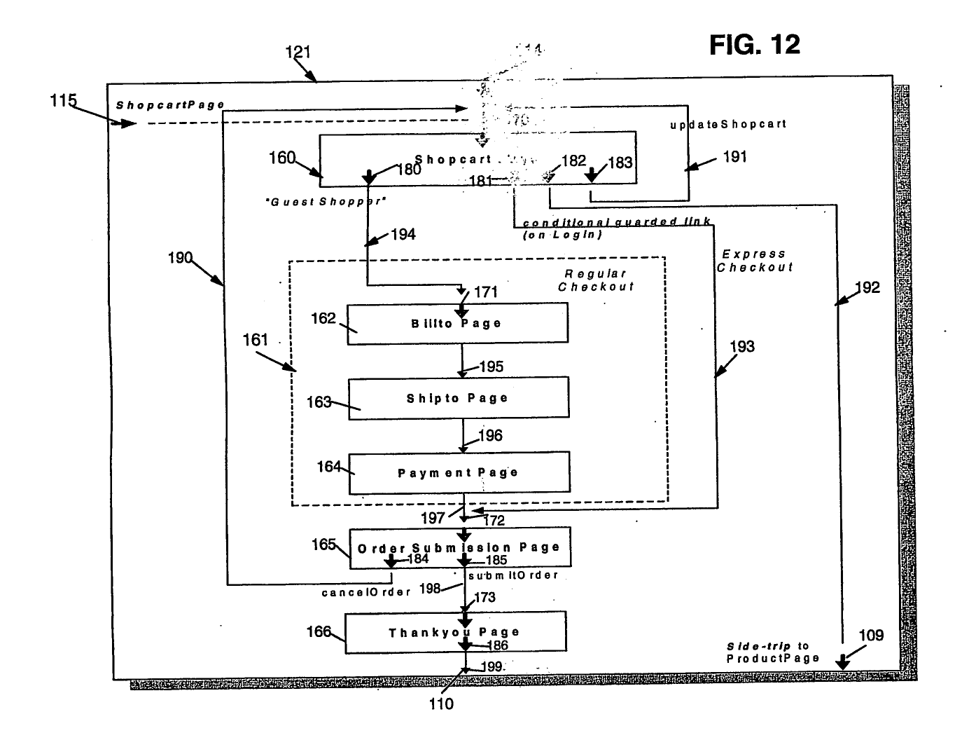

The purpose of the Checkout section, 121, depicted in detail in FIG. 12, is to represent the checkout process which every shopper must go through in order to exit the store with a successful purchase. Conceptually, the process itself is very simple. Equipped with the shopcart at hand, the shopper may start with the checkout process immediately. At the end of this process, the merchant needs to collect some relevant information from the shopper in order to process the purchase properly. This is the list of the required information (in no particular order): Bill to information, Ship to information, and Payment information. Conceptually, it does not matter how this information is collected, but of course it does matter to the shopper how the steps are presented to the shoppers (e.g. single-click vs 2-click vs n-click models).

From the shopper viewpoint, there are several “metaphors” in the Checkout process. Two of the most common metaphors are Regular Checkout and Express Checkout. Regular checkout, 161, which requires more steps (proceeding from the Shopcart page 160 by link 194 to Bill to page 162, Ship to page 163, and Payment page 164) to go through in the process, but offers more flexibility by allowing the shoppers to enter, change, or update the required information along the way. Express checkout, following link 193 from Shopcart page 160, requires less steps (i.e. 1 or 2 click process), but it makes certain assumptions about Bill to, Ship to, and Payment information which would have been ordinarily attended to by the respective pages. This information will be taken from the registration information. Therefore, only “registered” shoppers may use the Express Checkout, whereas any user (both “guest” and “registered” shopper) may use the Regular Checkout. The difference is that the Bill to, Ship to, and Payment information can be retrieved from registration records generated by the commerce servers for “registered” shoppers, and can be presented as the default values on the different forms. This is obviously not possible for “guest” shoppers.

On the shopping cart page, 160 the shopper may select to continue with the shopping process via regular or express checkout. There are different exit ports for each checkout process. Regular checkout does not require authentication and the shopper is expected to fill in the blank forms. Express checkout requires authentication which in turn requires registration. This elaborate process is represented by a conditional guarded link (on authentication) similar to that depicted in FIG. 8. First, we must check if the shopper has been authenticated. If this is the case, the shopper may proceed to the destination page which is the Order Submission page, 165. Otherwise, the shopper will be lead to the Login section which will be described later. Upon successful authentication, the shopper may proceed to the Order Submission page. Note that this conditional guarded link is an abstraction to make the architecture description simpler.

Customer Service Area

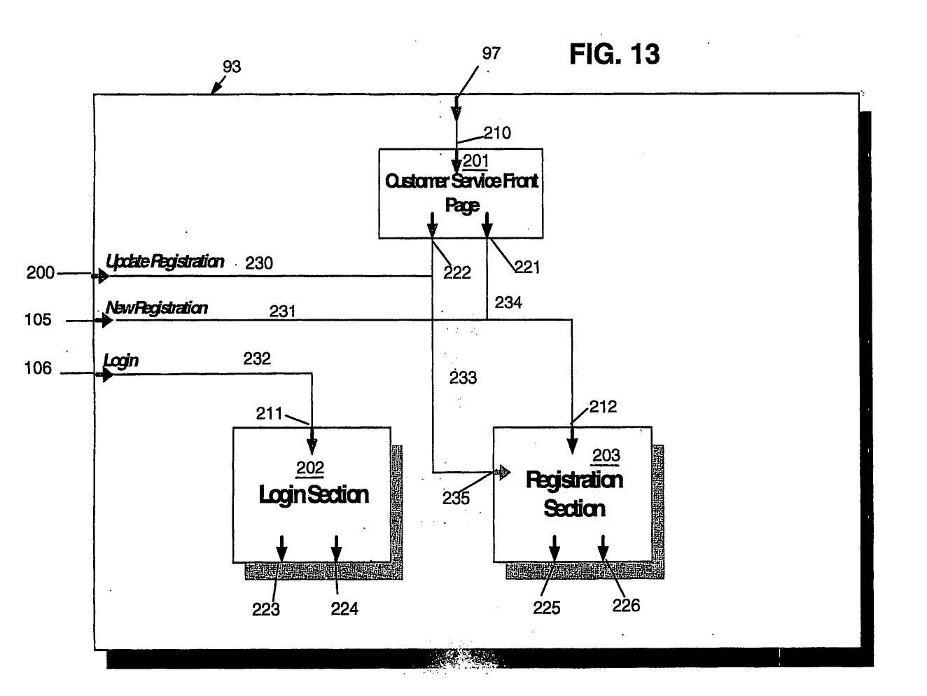

Referring to FIG. 13, the Customer service Area is a collection of sections intended (as the name suggests) to offer services to the shoppers such as Login, Registration, etc. In this simple example, we are not showing other possible but useful sections such as Order Inquiry. Here, we choose to illustrate a front page, 201 which would explain the services available in this area (we could make this a “front” section if more than one page is needed to describe the Customer Service area). From this front page, the shopper may register by means of the Registration section 203, as a registered shopper or update shopper information.

Note that both Login, 202 and Registration, 203 sections are used as a guard in the path of some shopping processes. For example, in order to use the express checkout facility in the Checkout section, the shopper will have to be authenticated if this has not been done earlier. In this case, the shopper will be routed by link 193 (in FIG. 12) to the Login section, 202 for authentication. Such guarding section typically has at least two exit ports e.g. 223, 224 for success and failure respectively. The other notable property of such guarding section is that it is floating, i.e. the two exit ports are not linked to a fixed port. Instead, the target port of the links will be passed in at run-time. The failure exit port always return to the page of origin while the success port leads to a target component (e.g. Order Submission Page, 165, in FIG. 11) specified at run-time. These two sections are just checkpoints and are not the ultimate destination like other components. In FIG. 13, the exit ports 223, 224, of the Login Section 202, and exit ports 225, and 226 of the Registration Section 203 are not linked to other components as they are floating.

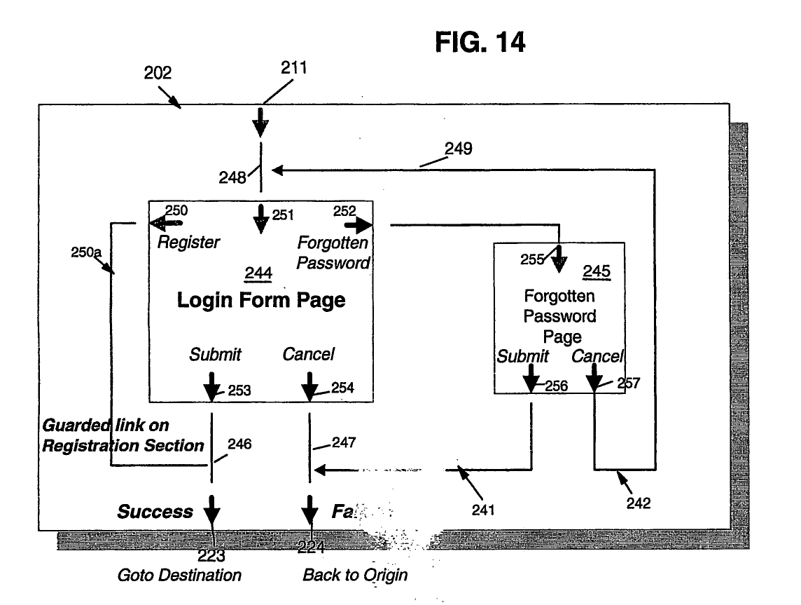

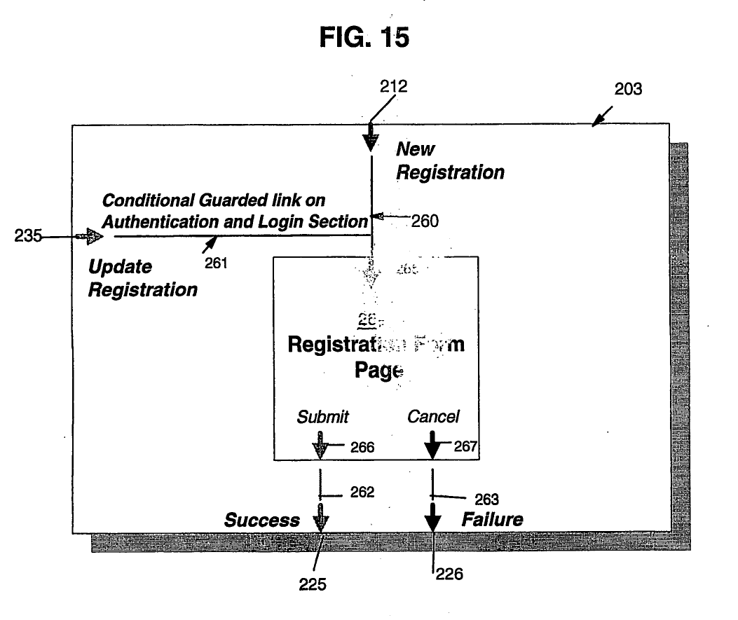

Note that each of these sections, Login and Registration, can be reached via the alternate entry ports of the area. These alternate entries are shown in FIGS. 14 and 15 respectively. So, it is possible to have a link from the Navigation Bar in the page frame, for example, to the Registration Section directly via the alternate entry link.

Login Section

FIG. 14 depicts details of Login section, 202, a guarding section used for authenticating shoppers. It will set the state of the shopper to “authenticated”, state if passed successfully. It is used in the shopping process requiring the identity of the shopper such as using the express checkout. Successfully passing the Login section will bring the shopper to the desired destination. Failure will bring the shopper back to the page of origin. Both URLs are passed in when entering this section.

As depicted in FIG. 14, the Login section consists of two pages. The Login page, 244, is a form in which the shopper may enter a login id and password. Successful login will lead from the submit exit port 253 via link 246 to the Success exit port, 223 of the section. As mentioned earlier, entering the wrong user id or password will bring the same form back with the appropriate error message. Cancelling the login page will lead to the failure exit port, 224 of the section.

If the shopper forgets his/her password, the Forgotten Password Page, 245 should be visited via the link, 249 provided. This page explains the site policy on this matter. Submitting request for a new password in this page will trigger an e-mail notification to the shopper with a new generated password. Canceling this form will lead to the Login page by link 242. The shopper may also choose to register if this has not been done before. This is represented by a guarded link, 250a, on Registration section connecting the “register” exit port, 250 on the Login page, 244 to the “Success” exit port of the section, 223. This one link represent the abstraction of the registration process. If this registration process is successful, the success exit port of the section will be followed leading to its destination. Failure in registration will lead the shopper back to the Login page, 244. This is an example of an abstraction that helps simplify the modeling of site architectures.

Registration Section

The registration section, 203, described in FIG. 15, is a guarding section used for two purposes. The first one is to provide registration facility for new shoppers, by link 260, accessed by entry port 212. The second is to allow registered shopper to update or change registration information (including password) by link 261, accessed by entry port 235. Updating registration information requires shopper authentication unless earlier authenticated. To reflect this policy, the link, 261 from the corresponding entry port, 235 into the Registration Form page, 264 is a conditional guarded link on on shopper authentication and the Login section, 202. The entry port 265 is used for both registration processes, new and updated. Canceling on the registration (new or update) will bring the shopper to the page of origin. Errors in entering the form will lead to the same form with error messages as described in an earlier section. Successful completion of the form will bring the shopper to the desired destination. In a more complex registration process, this section may contain more than one page. The success exit port 225, and the failure exit port 226 are illustrated together with their links from the registration form page 264.

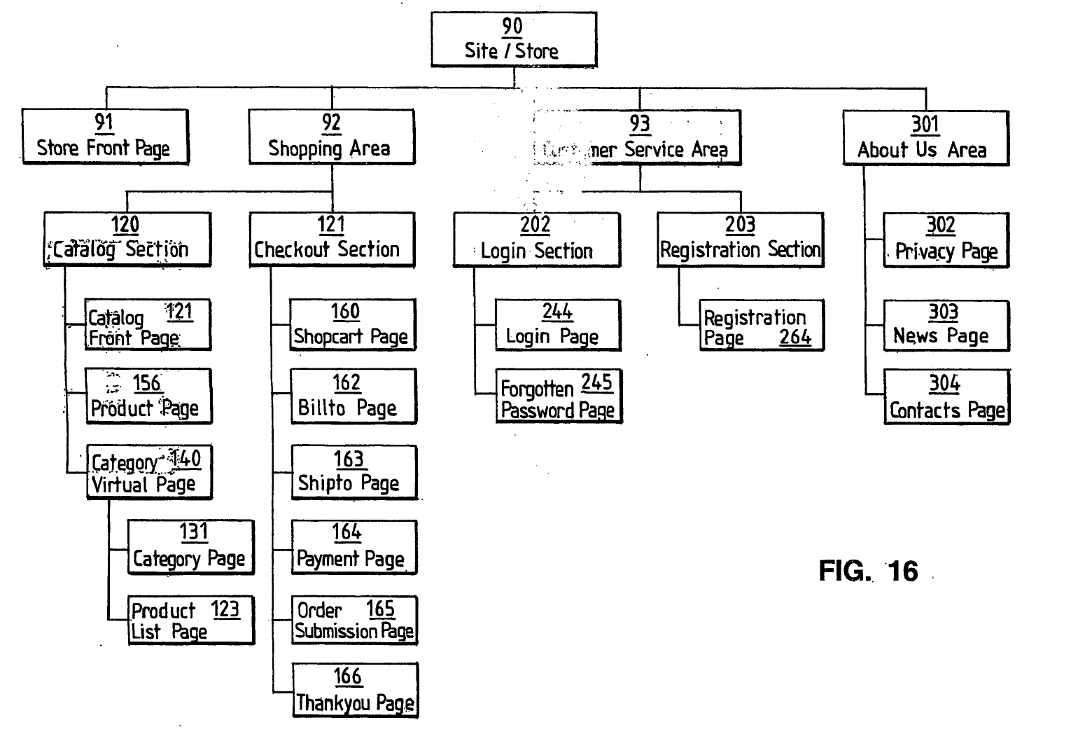

FIG. 16 depicts the hierarchical structure of a store web site developed in accordance with the instant invention, as described above, showing the containment relationships of the components of the web site.

The Applications of Site Architectures

The benefits of having an architecture in software development have been articulated in [5]. Many of the benefits described there are also applicable for Site Architecture. One strong benefit is being able to see and review the blueprint of the site before it is built. The site architecture document can also be used as the vehicle for communication among the stakeholders such as potential customers, creative design group, programming group, and project management. Another benefit is perhaps the potential of reuse from component templates design to component implementation. Also changing the implementation of some component such as Checkout section is localized to that component only, without disturbing the rest of the site.

### REFERENCES

[1] G. Booch. When worlds collide. From http://www.developer.ibm.com/library/articles/worldscollide.html.
[2] N. Kassem and the Enterprise Team. Designing Enterprise Applications with the Java™ 2 Platform, Enterprise Edition. Addison-Wesley, 2000.
[3] E. Gamma et al. Design Patterns, Elements of Reusable Object-Oriented Software. Addison-Wesley, 1995.
[4] G. Booch, I. Jacobson, and J. Rumbaugh. The Unified Modeling Language User Guide. Addison-Wesley, 1998.
[5] L. Bass, P. Clement, and R. Kazman. Software Architecture in Practice.

Addison-Wesley, 1998.
[6] How Do You Define Software Architecture? From http://www.sei.cmu.edu/architecture/definitions.html.
   Trademarks

Java, JavaBeans, JavaServer Page, JSP, Enterprise JavaBeans, and EJB are registered trademarks of Sun Microsystems, Inc in the U.S. and other countries.

1. A method of establishing in a data processing system capable of being linked to the internet a hierarchically structured store web site for use on the internet comprising:
establishing in the data processing system: a base store site module having at least one entry port for communication with the internet;
at least one child module of the base store site module having an entry port; and
the entry port of the base store site module being linked to the entry port of the child module for communication between the base store site and the child module.

2. A method as claimed in claim 1 wherein the at least one child module has an entry port and an exit port.

3. A method as claimed in claim 1 wherein the at least one child module has at least one entry port and at least one exit port; and the base module has at least one entry port; at least one of the entry ports of the child is linked to at least one entry port of the base module.

4. A method as claimed in claim 1 wherein the at least one child module has at least one entry port and at least one exit ports; the base module has at least one entry port and at least one exit port; and at least one of the entry ports of the child is linked to at least one entry port of the base module.

5. A method as claimed in claim 3 wherein at least one of the entry ports, and at least one of the exit ports of the at least one child module are linked, respectively, to at least one of the base module's entry ports, and at least one of the base module's exit ports.

6. A method as claimed in claim 1 wherein the base module has a plurality of entry ports, and at least some of the plurality of entry ports of the base module are linked to the entry port of the at least one child module.

7. A method as claimed in claim 3 wherein the at least one of child module has a plurality of exit ports, and at least some of the plurality of exit ports of the child module are linked to one exit of the base module.

8. A method as claimed in claim 1 wherein at least one of the exit ports of the at least one child module is linked to at least one of the entry ports of another child module.

9. A method as claimed in claim 1 wherein the base store site module has at least one entry port for communication with the internet; the at least one child module being selected from the set comprising:
a store front (page) module,
a shopping (area) module,
a customer service (area) module,
an information (area) module, or
an auction (area) module.

10. A method as claimed in claim 9 wherein the base store site module has at least one entry port for communication with the internet and at least one exit port;
the at least one exit port of the base store site module being available for linking with an exit port of a child module.

11. A system for a hierarchically structured store web site for use on the internet comprising:
means for a base store site module having at least one entry port for communication with the internet; and,
means for at least one child module of the base store site module having means for an entry port;
means for the entry port of the base store site module being linked to the entry port of the child module for communication between the base store site and the child module.

12. A computer program product directly loadable into the internal memory of a digital computer, comprising software code portions for performing the steps of any one of claim 1 to claim 10 when said product is run on a computer.
